(19) United States
(12) Patent Application Publication
(10) Pub. No.: US 2018/0326456 A1
(43) Pub. Date: Nov. 15, 2018

(54) PRESSURE SENSOR, AND COMPOSITE ELEMENT AND ELECTRONIC DEVICE HAVING SAME

(71) Applicant: MODA-INNOCHIPS CO., LTD., Ansan-Si, Gyeonggi-Do (KR)

(72) Inventors: In Kil PARK, Seongnam-Si, Gyeonggi-Do (KR); Jun Ho JUNG, Siheung-Si, Gyeonggi-Do (KR)

(21) Appl. No.: 15/774,264

(22) PCT Filed: Nov. 4, 2016
(86) PCT No.: PCT/KR2016/012680

§ 371 Date: May 7, 2018

(30) Foreign Application Priority Data
Nov. 6, 2015 (KR) 10-2015-0156158
Nov. 16, 2015 (KR) 10-2015-0160636
Nov. 26, 2015 (KR) 10-2015-0166550
Oct. 31, 2016 (KR) 10-2016-0143269
Nov. 3, 2016 (KR) 10-2016-0145766
Nov. 3, 2016 (KR) 10-2016-0145767

(51) Int. Cl. B06B 1/06; G01L 1/14; G01L 5/00; G06F 3/041; G06F 3/044; G10K 9/122

(52) U.S. Cl. CPC B06B 1/0622; G01L 1/14; G01L 5/0028; G10K 9/122; G06F 3/0414; G06F 3/044; G06F 3/0412

(57) ABSTRACT

A pressure sensor includes first and second electrode layers spaced apart from each other; and a dielectric layer provided between the first and second electrode layers provided between the first and second electrode layers. The dielectric layer is compressible and restorable, and includes at least one among a material with a hardness of 10 or less, a plurality of dielectric bodies with a dielectric constant of 4 or less, and a plurality of pores.

### TECHNICAL FIELD

The present disclosure relates to a pressure sensor, and more particularly, to a pressure sensor provided with a pressure sensor capable of preventing a touch input error and a composite element and electronic device which are provided with the same.

### BACKGROUND ART

In order to operate electronic devices such as various mobile communication terminals, various types of input devices are being used. For example, input devices such as buttons, keys, and a touch screen panel are being used. A touch screen panel, that is, a touch input device detects the touch of a human body and enables an electronic device to be easily and simply operated only by a light touch. Therefore, the use thereof is being increased. For example, touch input devices are also used for operation of mobile communication terminals, home electrical products, industrial devices, automobiles, and the like.

Touch input devices used for electronic devices, such as mobile communication terminals, may each be provided between a protective window and a liquid crystal display panel displaying an image. Accordingly, characters, symbols, and the like are displayed from a liquid crystal display panel through the window, and when a user touches the corresponding portion, the touch sensor determines the position of the touch and performs a specific processing according to a control flow.

The touch input devices each have a technical means which detects and recognizes touch or non-touch of a human body (finger) or a pen using the detection of human body current due to the touch or a change in pressure, temperature, or the like. In particular, pressure sensors, which detect touch or non-touch of the human body or a pen using a pressure change, have been spotlighted.

The pressure sensors each have a structure in which an air gap or a material such as silicone which can be compressed and restored is provided between two electrodes. Such pressure sensors may detect the change in electrostatic capacitance according to the distance between two electrodes due to a touch pressure and thereby detects a pressure. However, when an air gap is formed, since the dielectric constant of air is 1, in order to sense the capacitance value due to a change in distance between two electrodes, a large amount of change in distance is necessary between the two electrodes, and since a silicone material also generally has a dielectric constant of 4 or less, a large amount of change is necessary between the two electrodes.

### PRIOR ART DOCUMENTATIONS

Korean Patent Application Laid-open Publication No. 2014-0023440

Korean Patent Registration No. 10-1094165

### PRESENT DISCLOSURE

### Technical Problem

The present disclosure provides a pressure sensor capable of preventing a touch input error.

The present disclosure provides a pressure sensor capable of precisely sensing, even when a change between two electrodes is minute, a change in capacitance value due to the change.

The present disclosure provides a composite element and an electronic device which are provided with the pressure sensor.

### Technical Solution

In accordance with an aspect of the present invention, a pressure sensor includes: first and second electrode layers spaced apart from each other; and a dielectric layer provided between the first and second electrode layers, wherein the dielectric layer is compressible and restorable, and includes at least one among a material with a hardness of 10 or less, a plurality of dielectric bodies with a dielectric constant of 4 or less, and a plurality of pores.

The pressure further includes a plurality of holes formed in at least any one of the first and second electrode layers.

The dielectric layer further includes a material for shielding and absorbing electromagnetic waves.

The dielectric layer includes the dielectric bodies which are formed in a content of 0.01% to 95% based on 100% of the dielectric layer.

The dielectric layer has a porosity of 1% to 95%.

The pores are formed in two or more sizes and in at least one or more shapes.

The dielectric layer has at least one region having a porosity or a pore size different from other regions.

The dielectric layer has a smaller pore cross-sectional area ratio in a vertical cross-section thereof than in the horizontal cross-section thereof.

The dielectric layer has a dielectric constant of 2 to 20.

The dielectric layer is formed in a thickness of 500 μm or less.

The pressure sensor further includes an insulating layer provided on at least one among places on the first electrode layer, between the first and second electrode layers, and under the second electrode layer.

The pressure sensor further includes first and second connection patterns respectively provided on the first and second electrode layers and connected to each other.

In accordance with another aspect of the present invention, a complex device includes: a pressure sensor in accordance with the aspect of the present invention; and at least one functional part having a function different from that of the pressure sensor.

The pressure sensor may enable the functional part.

The functional part may include a piezoelectric device provided on one side of the pressure sensor; and a vibration plate provided on one side of the piezoelectric device.

The pressure sensor enables the functional part.

The functional part includes: a piezoelectric device provided on one side of the pressure sensor; and a vibration plate provided on one side of the piezoelectric device.

The piezoelectric device is used as a piezoelectric vibration apparatus or a piezoelectric acoustic apparatus according to a signal applied thereto.

The functional part is provided on one side of the pressure sensor and includes at least one among an NFC, a WPC, and an MST antenna each of which includes at least one antenna pattern.

The functional part includes: a piezoelectric device provided on one surface of the pressure sensor; a vibration plate provided on one surface of the piezoelectric device; and at least one among an NFC, a WPC, and a MST which are provided on the other surface of the pressure sensor or on one surface of the vibration plate.

The complex device includes a fingerprint detection unit electrically connected to the pressure sensor and configured to measure, from the pressure sensor, a difference in acoustic impedance generated by an ultrasonic signal at valleys and ridges of the fingerprint and thereby detects the fingerprint.

In accordance with yet another aspect of the present invention, an electronic device includes: a window; a display part configured to display an image through the window; and a pressure sensor configured to detect a position and a pressure of a touch input applied through the window, wherein the pressure sensor includes a pressure sensor in accordance with one aspect of the present invention.

The pressure sensor includes at least any one of at least one first pressure sensor provided under the display part; and at least one second pressure sensor provided under the window.

The electronic device further includes a touch sensor provided between the window and the display part.

The pressure sensor further includes a bracket provided on at least one among places on the first electrode layer, between the first and second electrode layers, and under the second electrode layer.

At least a portion of at least any one among the first and second electrode layers is formed on the bracket.

### Advantageous Effects

A pressure sensor in accordance with an exemplary embodiment includes: first and second electrode layers which are spaced apart from each other; and a dielectric layer formed between first and second electrode layers, wherein the dielectric layer may be compressed and restored and includes at least one among a material with a hardness of 10 or less, a plurality of dielectric bodies with a dielectric constant of 4 or less, and a plurality of pores. In addition, in another exemplary embodiment, a dielectric layer may be compressed and restored, and may thus be formed including a plurality of pores. In addition, in yet another exemplary embodiment, a dielectric layer is formed such that dielectric bodies with dielectric constants greater than 4 are mixed with an insulating material, and thus, the dielectric constant of the dielectric layer may be 4 or more.

In exemplary embodiments, the dielectric layer may be compressed and restored, be formed of a material with a hardness of 10 or less, or be formed so as to include a plurality of pores or have a several thousand times larger dielectric constant than air. Accordingly, even when the touch input of a user is minute, since an amount of change between the first and second electrodes is large, sufficient data may be obtained. That is, the resolution is improved due to the amount of change in a capacitance value, whereby a pressure sensor, the data of which is easily processed, may be manufactured.

In addition, since a lot of amounts of change are not necessary between the first and second electrodes, the thickness may be minimized, the thickness of the pressure may be reduced, and the thickness of a module using the pressure sensor may be reduced.

Meanwhile, the pressure sensor in accordance with an exemplary embodiment may be adopted in an electronic device in which a predetermined function is performed through a touch input. In addition, the pressure sensor may be integrated with a piezoelectric device functioning as a piezoelectric acoustic device or a piezoelectric vibration device and may also be integrated with NFC, WPC, and MST.

### BRIEF DESCRIPTION OF THE DRAWINGS

FIG. 1 is a cross-sectional view of a pressure sensor in accordance with a first exemplary embodiment;

FIGS. 2 and 4 are schematic plan views of first and second electrode layers of a pressure sensor in accordance with exemplary embodiments;

FIGS. 5 to 9 are cross-sectional views of pressure sensors in accordance with other exemplary embodiments;

FIGS. 10 and 11 are schematic plan views of first and second electrode layers of a pressure sensor in accordance with other exemplary embodiments;

FIGS. 12 and 13 are a front perspective view and a rear perspective view which are provided with pressure sensors in accordance with a first exemplary embodiment;

FIG. 14 is a partial cross-sectional view taken along line A-A′ of FIG. 12;

FIG. 15 is a cross-sectional view of an electronic device in accordance with a second exemplary embodiment;

FIG. 16 is a schematic planar view illustrating a disposition form of a pressure sensor of an electronic device in accordance with a second exemplary embodiment;

FIG. 17 is a cross-sectional view of an electronic device provided with a pressure sensor in accordance with a third exemplary embodiment;

FIG. 18 is a schematic planar view illustrating a disposition form of a pressure sensor of an electronic device in accordance with a fourth exemplary embodiment;

FIGS. 19 to 22 are control configuration diagrams for pressure sensors in accordance with exemplary embodiments;

FIG. 23 is a block diagram for describing a data processing method of a pressure sensor in accordance with another exemplary embodiment;

FIG. 24 is a configuration diagram of a fingerprint recognition sensor employing a pressure sensor in accordance with exemplary embodiments;

FIG. 25 is a cross-sectional view of a pressure sensor in accordance with another exemplary embodiment; and

FIGS. 26 to 30 are views of an integrated complex device in accordance with various exemplary embodiments.

### DETAILED DESCRIPTION

Hereinafter, exemplary embodiments of the present invention will be described in detail with reference to the accompanying drawings. The present invention may, however, be embodied in different forms and should not be construed as limited to the embodiments set forth herein. Rather, these embodiments are provided so that this invention will be thorough and complete, and will fully convey the scope of the present invention to those skilled in the art.

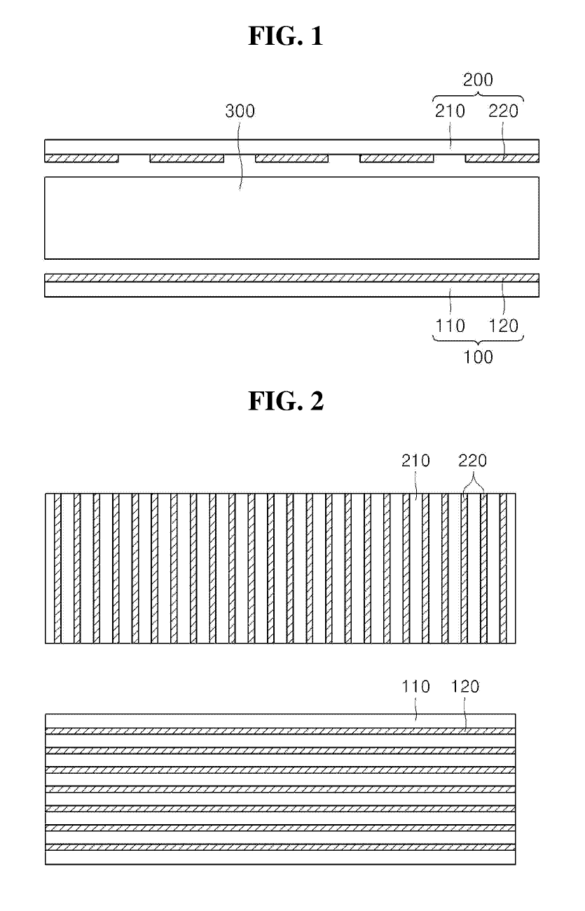

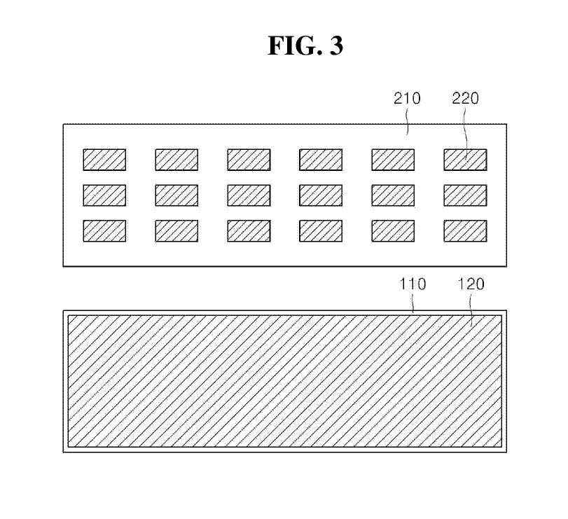

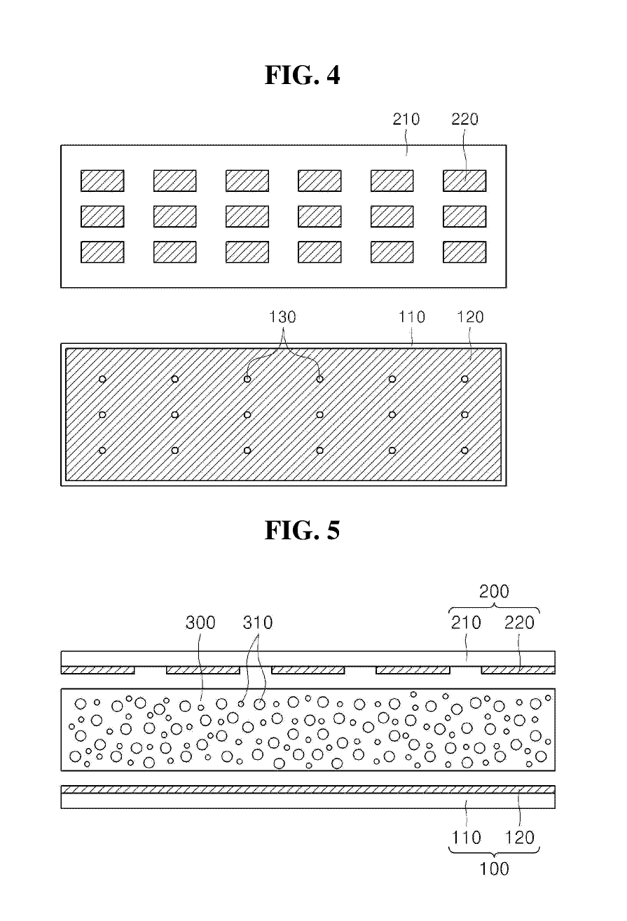

FIG. 1 is a cross-sectional view of a pressure sensor in accordance with a first exemplary embodiment, and FIGS. 2 and 4 are schematic views of first and second electrode layers of a pressure sensor.

Referring to FIG. 1, a pressure sensor in accordance with a first exemplary embodiment includes: first and second electrode layers 100 and 200 which are spaced apart from each other; and a dielectric layer 300 provided between the first and second electrode layers 100 and 200. At this point the dielectric layer 300 may be compressed and restored, and be formed by using a material with a hardness of 10 or less.

1. Electrode Layer

The first and second electrode layers 100 and 200 are spaced apart from each other in the thickness direction (that is, the vertical direction) and the piezoelectric layer 300 is provided therebetween. The first and second electrode layers 100 and 200 may include: first and second support layers 110 and 120; and first and second electrodes 120 and 220 which are respectively formed on the first and second support layers 110 and 210. That is, the first and second support layers 110 and 210 are formed to be spaced a predetermined distance apart from each other, and the first and second electrodes 120 and 220 are respectively formed on the surfaces of the first and second support layers 110 and 210. Here, the first and second electrodes 120 and 220 may be formed in directions facing each other, or may also be formed not facing each other. That is, the first and second electrodes 120 and 220 may be formed to face the piezoelectric layer 300, also be formed such that any one thereof faces the dielectric layer 300 and the other does not dace the dielectric layer 300, or may both be formed not to face the dielectric layer. At this point, the first and second electrodes 120 and 220 may be formed to be in contact with or also to be not in contact with the dielectric layer 300. For example, the pressure sensor in accordance with an exemplary embodiment may be implemented by the first support layer 110, the first electrode 120, the dielectric layer 300, the second electrode 220, and the second support layer 210 being stacked in the thickness direction from the bottom side. Here, the first and second support layers 110 and 210 support the first and second electrodes 120 and 220 so that the first and second electrodes 120 and 220 are respectively formed on one surface of the first and second support layers 110 and 210. To this end, the first and second support layers 110 and 210 may be provided in a plate shape having a predetermined thickness. In addition, the first and second support layers 110 and 210 may also be provided in a film shape so as to have flexible characteristic. Such first and second support layers 110 and 210 may be formed by using silicone, urethane, and polyurethane, polyimide, PET, PC, or the like, and may also be formed by using a prepolymer formed by using a photocurable monomer, an oligomer, a photoinitiator, and additives. In addition, optionally, the first and second support layers 110 and 210 may be transparent or also be opaque. Meanwhile, a plurality of pores (not shown) may be provided in at least one of the first and second support layers 110 and 210. For example, the second support layer 210, the shape of which may be deformed by being bent downward due to a touch or press of an object, may include a plurality of pores. The pores may have sizes of 1 μm to 500 μm and be formed in a porosity of 10% to 95%. The plurality of pores are formed in the second support layer 210, and thus, the elastic force and restoring force of the second support layer 210 may be improved. At this point, when the porosity is 10% or less, the improvement of the elastic force and the restoring force may be insignificant, and when the porosity is greater than 95%, the shape of the second support layer 210 may not be maintained. Also, preferably, the support layers 110 and 220 having the plurality of pores do not have pores formed in the surface thereof. That is, when pores are formed in one surface on which the electrodes 120 and 220 are formed, the electrodes 120 and 220 may be disconnected or the thickness of the electrodes may increase. Therefore, preferably, pores are not formed in the one surface on which the electrodes 120 and 220 are formed.

The first and second electrodes 120 and 220 may be formed of a transparent conductive material such as an indium tin oxide (ITO) and an antimony tin oxide (ATO). However, besides such materials, the first and second electrodes 120 and 220 may also be formed of another transparent conductive material, and also be formed of an opaque conductive material such as silver (Ag), platinum (Pt) and copper (Cu). Also, the first and second electrodes 120 and 220 may be formed in directions crossing each other. For example, the first electrode 120 may be formed in one direction so as to have a predetermined width, and further formed at intervals in other direction. The second electrode 220 may be formed in another direction perpendicular to the one direction so as to have a predetermined width, and further formed at intervals in the one direction perpendicular to the another direction. That is, as illustrated in FIG. 2, the first and second electrodes 120 and 220 may be formed in directions perpendicular to each other. For example, the first electrode 120 may be formed to have predetermined width in the horizontal direction and further formed in plurality in the vertical direction to be arranged at intervals, and the second electrode 220 may be formed to have predetermined widths in the vertical direction and further formed in plurality in the horizontal direction to be arranged at intervals. Here, the widths of the first and second electrodes 120 and 220 may be equal to or larger than the respective intervals therebetween. Of course, the widths of the first and second electrodes 120 and 220 may also be smaller than the intervals therebetween, but preferably, the widths are larger than the intervals. For example, the ratio of the width to the interval in each of the first and second electrodes 120 and 220 may be 10:1 to 0.5:1. That is, when the interval is 1, the width may be 10 to 0.5. Also, the first and second electrodes 120 and 220 may be formed in various shapes besides such a shape. For example, as illustrated in FIG. 3, any one of the first and second electrode 120 and 220 may entirely be formed on a support layer, and the other may also be formed in a plurality of approximately rectangular patterns having predetermined widths and spaced apart predetermined distances from each other in one direction and another direction. That is, a plurality of first electrodes 120 may be formed in approximately rectangular patterns, and the second electrode 220 may entirely be formed on the second support layer 210. Of course, aside from rectangles, various patterns such as circles and polygons may be used. In addition, any one of the first and second electrodes 120 and 220 may entirely be formed on a support layer, and the other may also be formed in a lattice shape which extends in one direction and another direction. Meanwhile, the first and second electrodes 120 and 220 may be formed in a thickness such as 0.1 μm to 500 μm, and the first and second electrodes 120 and 220 may be provided at intervals such as 1 μm to 10,000 μm. Here, the first and second electrodes 120 and 220 may be in contact with the dielectric layer 300. Of course, the first and second electrodes 120 and 220 maintain the states of being spaced a predetermined distance apart from the dielectric layer 300, and when a predetermined pressure, such as user's touch input, is applied, at least any one of the first and second electrodes 120 and 220 may locally be in contact with the dielectric layer 300. At this point, the dielectric layer 300 may also be compressed to a predetermined depth.

Meanwhile, a plurality of holes 130 (not shown) may be formed in at least any one of the first and second electrode layers 100 and 200. For example, as illustrated in FIG. 4, a plurality of holes 130 may be formed in the first electrode layer 100. That is, the plurality of holes 130 may be formed in the electrode layer used as a ground electrode. Of course, besides the first electrode layer 100, the holes 130 may also be formed in the second electrode layer 200 used as a signal electrode and may also be formed in both the first and second electrode layers 100 and 200. In addition, the holes 130 may also be formed such that at least any one of the first and second electrodes 120 and 220 is removed and the first and second support layers 110 and 210 are exposed, and also be formed such that not only the first and second electrodes 120 and 220, but also the first and second support layers 110 and 210 are removed. That is, the holes 130 may also be formed such that the electrodes 120 and 220 are removed and the support layers 110 and 210 are thereby exposed, or also be formed so as to pass through the support layers 110 and 210 from the electrodes 120 and 220. Also, the holes 130 may be formed in a region in which the electrodes 120 and 220 overlap. For example, as illustrated in FIG. 4, the plurality of holes 130 may be formed in the first electrode 120 in the region overlapping the second electrode 220. Here, a single hole 130 may also be formed in the region overlapping the second electrode 220, and two or more holes may also be formed. Of course, as illustrated in FIG. 2, also in the case in which the first and second electrodes 120 and 220 are formed in one direction and another direction perpendicular to the one direction, the holes 130 may be formed in a region at which the first and second electrodes 120 and 220 cross each other. Due to the formation of the holes 130, the dielectric layer 300 may be more easily compressed. Such a hole 130 may be formed in a diameter such as 0.05 mm to 10 mm. When the diameter of the hole 130 is less than 0.05 mm, the compression effect of the dielectric layer 300 may decrease, and when the diameter is greater than 10 mm, the restoring force of the dielectric layer 300 may decreased. However, the size of the hole 130 may be variously changed according to the size of a pressure sensor or an input device.

2. Dielectric Layer

The dielectric layer 300 is provided in a predetermined thickness between the first and second electrode layers 100 and 200, and may be provided in a thickness such as 10 μm to 5000 μm. That is, the dielectric layer 300 may be provided in various thicknesses according to the size of an electronic device in which a pressure sensor is adopted. For example, the dielectric layer 300 may be provided in a thickness of 10 μm to 5000 μm, preferably, 500 μm or less, and more preferably, 200 μm or less. The dielectric layer 300 may be formed such that a space, that is, an air gap, is not formed therein. That is, when a space is formed inside the dielectric layer 300, foreign substances or moisture may penetrate into the space, and accordingly, the dielectric constant of the dielectric layer 300 is changed and a sensing value may thereby be affected. Therefore, in an exemplary embodiment, the dielectric layer 300 in which a space or the like are not formed may be used. In addition, a material the thickness of which may be changed due to a pressure change may be used for the dielectric layer 300. That is, a material which can be compressed and restored may be used for the dielectric layer 300. Such a dielectric layer 300 may be formed of a material with a hardness of 10 or less. For example, the dielectric layer 300 may have a hardness of 0.1 to 10, preferably a hardness of 2 to 10, and more preferably a hardness of 5 to 10. To this end, the dielectric layer 300 may be formed by using, for example, silicone, gel, rubber, urethane, or the like. Meanwhile, the dielectric layer 300 may further contain a material for shielding and absorbing electromagnetic waves. As such, the material for shielding and absorbing electromagnetic waves is further contained in the dielectric layer 300, whereby the electromagnetic waves may be shielded or absorbed. The material for shielding and absorbing electromagnetic waves may include ferrite, alumina, or the like, and may be contained in an amount of 0.01 wt % to 50 wt % in the dielectric layer 300. That is, based on 100 wt % of the materials constituting the dielectric layer 300, 0.01 wt % to 50 wt % of the material for shielding and absorbing electromagnetic waves may be contained. When the content of the material for shielding and absorbing electromagnetic waves is 0.01 wt % or less, the electromagnetic wave shielding and absorbing characteristic may be low, and when the content exceeds 50 wt %, the compression characteristic of the dielectric layer 300 may be decreased.

As described above, the pressure sensor in accordance with an exemplary embodiment does not have a spacer between the first and second electrode layers 100 and 200, and may have a dielectric layer 300 formed of a material with a hardness of 10 or less. Due to the formation of the spacer, penetration of foreign substances, moisture or the like may be prevented, and thus, the dielectric constant of the dielectric layer 300 is not changed and the change in a sensing value may thereby be prevented. In addition, since an amount of change between the first and second electrodes increases even by a slight touch input, sufficient data may be obtained. Accordingly, the resolution is improved due to the amount of change in a capacitance value, whereby a pressure sensor, the data of which is easily processed, may be manufactured. In addition, since a large change in thickness is not necessary between the first and second electrode layers 100 and 200, the thickness may be minimized, and thus, the thickness of the pressure sensor and the pressure sensor module may be reduced.

FIG. 5 is a cross-sectional view of a pressure sensor in accordance with a second exemplary embodiment.

Referring to FIG. 5, a pressure sensor in accordance with a first exemplary embodiment includes: first and second electrode layers 100 and 200 which are spaced apart from each other; and a dielectric layer 300 provided between the first and second electrode layers 100 and 200, wherein the dielectric layer 300 may be formed such that the dielectric layer can be compressed and restored and has a plurality of pores 310.

The pores 310 may be formed in sizes of 1 μm to 10,000 μm. Here, the sizes of the pores 310 may be the shortest diameter, be the longest diameter, or also be the average diameter thereof. Among these, the shorted diameter may be 1 μm to 500 μm. For example, the pores 310 may be formed in sizes of 1 μm to 10,000 μm, also be formed in sizes of 1 μm to 5,000 μm, and also be formed in sizes of 1 μm to 1,000 μm That is, the sizes of the pores 310 can be variously changed according to the size of a pressure sensor, the size of an electronic device in which the pressure sensor is adopted, the thickness and width of the dielectric layer 300, or the like. In addition, the pores 310 may be formed in the same size or sizes different from each other. For example, a dielectric layer 300 may be formed by mixing: first pores having an average size of 1 μm to 300 μm, second pores having an average size of 300 μm to 600 μm, and third pores having an average size of 600 μm to 1,000 μm. At this point, the first to third pores may also have a plurality of sizes. That is, the first to third pores may respectively have average sizes, and have a plurality of sizes within respective average sizes. As such, using pores 310 having a plurality of sizes, small pores may be formed between large pores, and thus, the porosity may further be improved. Such pores 310 may have various shapes. The cross-sectional shapes of the pores 310 may be formed in, for example, circles or ellipses, and at least a portion may also be formed in shapes extending toward one side. In addition, adjacent pores 310 may be at least partially connected to each other, and in this case, the pores 310 may also be formed in peanut shapes. Meanwhile, according to the thickness of the dielectric layer 300, the sizes of the pores 310 may be larger than the thickness of the dielectric layer 300. In this case, the pores 310 are formed in the thickness direction of the dielectric layer 300, and thus, a vacant region may be provided between the first and second electrode layers 100 and 200. However, when the sizes of the pores 310 increase and the vacant region is thereby provided in the dielectric layer 300, the compression force is weakened and a large sensing output may be obtained even with a small touch pressure. That is, the sensing margin may be improved. In addition, the pores 310 may be formed in a porosity of 1% to 95%. That is, the higher the porosity of the dielectric layer 300, the greater the dielectric layer 300 may be compressed even with a small touch pressure. However, when the porosity of the dielectric layer 300 is too high, the shape of the dielectric layer 300 is not easily maintained, and a portion of the dielectric layer 300 may also be collapsed. Thus, preferably, the plurality of pores 310 have a porosity of 1% to 95% such that the dielectric layer 300 may be compressed into a predetermined size at a predetermined pressure and a portion of the dielectric layer 300 may not be collapsed and maintain the shape thereof. At this point, the higher the porosity, the higher the sensitivity may be. Meanwhile, the porosity may be defined as (the ratio of arbitrary vertical cross-sectional area of pores within 1 cm²+the ratio of arbitrary horizontal cross-sectional area of pores within 1 cm²)/2. In addition, preferably, the dielectric layer 300 has the same porosity in all the regions thereof. However, the dielectric layer 300 may have at least one region the porosity of which is 10% or more. For example, when at least one region of the dielectric layer 300 has a porosity of approximately 10% and at least another region has a porosity of 80%, a larger value of change in electrostatic capacitance may be sensed in the region with the greater porosity. However, even when a region has a density of 10% or more, a control unit may sufficiently sense the value of change in electrostatic capacitance according to the density. In addition, in the dielectric layer 300, the cross-sectional area ratio of the pores 310 in a vertical cross-section may be smaller than that of the pores 310 in a horizontal cross-section. That is, in at least one region, preferably, in all regions in the dielectric layer 300, the ratio of the cross-sectional area of the pores 310 in the vertical direction may be smaller than the ratio of the cross-sectional area of the pores 310 in the horizontal direction.

Meanwhile, the dielectric layer 300 may be formed of a material, the thickness of which may be changed due to a pressure change. That is, the dielectric layer 300 may be formed of a material which can be compressed and restored. In addition, the dielectric layer 300 may be formed of a material containing the pores 310. For example, the dielectric layer 300 may be formed of a material, such as foamed rubber, foamed silicone, foamed latex, formed urethane, which can be foamed and thereby contain pores 310 and can be compressed and restored. In addition, the dielectric layer 300 may be formed of a thermoplastic resin. The thermoplastic resin may include, for example, one or more elected from the group consisting of novolac epoxy resin, phenoxy-type epoxy resin, BPA-type epoxy resin, BPF0-type epoxy resin, hydrogenated BPA epoxy resin, dimer acid modified epoxy resin, urethane modified epoxy resin, rubber modified epoxy resin and DCPD-type epoxy resin. Of course, the dielectric layer 300 may be formed of a material with a hardness of 10 or less. The dielectric layer 300 formed of such a material may have a dielectric constant of 2-20 inclusive. Meanwhile, the dielectric layer 300 in accordance with a second exemplary embodiment may further include a material for shielding and absorbing electromagnetic waves as the first exemplary embodiment. The material for shielding and absorbing electromagnetic waves may have a smaller size than the pores 310, and may thus be contained in the pores 310. Of course, the material for shielding and absorbing electromagnetic waves may have a larger size than the pores 310, and may thus be contained in a region in which the pores 310 of the dielectric layer 300 are not formed. Of course, the material for shielding and absorbing electromagnetic waves may have a size larger than the pores 310, and may thus be contained in a region in which the pores 310 of the dielectric layer are not formed. Of course, the material for shielding and absorbing electromagnetic waves may have a plurality of sizes larger or smaller than the pores 310, and a portion thereof may thus be contained in the pores 310 or may be contained in the dielectric layer 300 in which the pores 310 are not formed. As such, the material for shielding and absorbing electromagnetic waves is further contained in the dielectric layer 300, whereby the electromagnetic waves may be shielded or absorbed. The material for shielding and absorbing electromagnetic waves may include ferrite, alumina, or the like, and may be contained in an amount of 0.01 wt % to 50 wt % in the dielectric layer 300. That is, based on 100 wt % of the materials constituting the dielectric layer 300, 0.01 wt % to 50 wt % of the material for shielding and absorbing electromagnetic waves may be contained. When the content of the material for shielding and absorbing electromagnetic waves is less than 0.01 wt %, the electromagnetic wave shielding and absorbing characteristic may be low, and when the content exceeds 50 wt %, the compression characteristic of the dielectric layer 300 may be decreased.

As described above, in the pressure sensor in accordance with a second exemplary embodiment, the dielectric layer 300 having the plurality of pores 310 may be formed between the first and second electrode layers 100 and 200. That is, in the dielectric layer 300, the plurality of pores 310 having a porosity of 1% to 95% may be formed. Accordingly, the amount of change between the first and second electrodes 120 and 220 increases even by a small pressure, and sufficient data may be obtained, and thus, the resolution due to the amount of change in the capacitance value is improved and a pressure sensor, the data of which can be easily processed, may be manufactured.

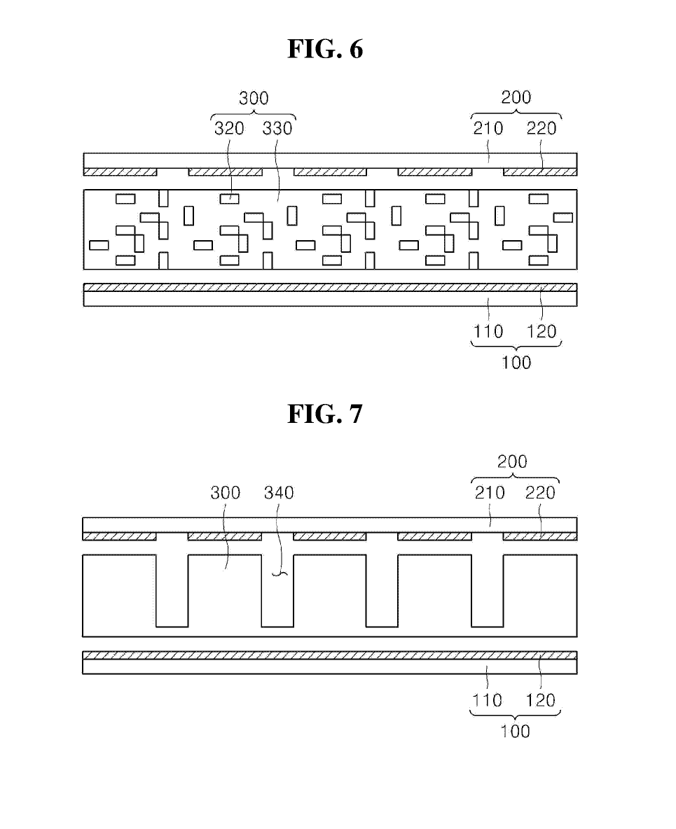

FIG. 6 is a cross-sectional view of a pressure sensor in accordance with a third exemplary embodiment.

Referring to FIG. 6, a pressure sensor in accordance with a third exemplary embodiment includes: first and second electrode layers 100 and 200; and a dielectric layer 300 provided between the first and second electrode layers 100 and 200, wherein a dielectric layer 300 may be provided such that a dielectric body 320 having a higher dielectric constant than silicone or rubber, for example, the dielectric constant of 4 or more, preferably, greater than 4 is mixed and provided in an insulating material 330, and accordingly, the dielectric layer 300 may have a dielectric constant of 4 or more, preferably, greater than 4. Meanwhile, the dielectric layer 300 may further include not only a dielectric body 230 but also the pores 310 described in the second exemplary embodiment.

The dielectric layer 300 may be provided, in the insulating material 330, with the dielectric body 320 having a dielectric constant greater than 4 and be formed in a predetermined thickness. Accordingly, the dielectric layer 300 may have a dielectric constant of 4 or more. The dielectric body 320 may be added in a powder shape with a size such as 1 μm to 500 μm. At this point, one kind of powder or two or more kinds of powder which have a plurality of sizes may be used for the dielectric body 320. For example, a first dielectric body powder having an average particle diameter of 1 μm to 100 μm, a second dielectric body powder having an average particle diameter of 100 μm to 300 μm, and a third dielectric body powder having an average particle diameter of 300 μm to 500 μm, may be mixed and used. As such, as the dielectric body powder having a plurality of sizes is used, small dielectric body powder particles may be incorporated between large dielectric body powder particles, and thus, the content of the dielectric body powder may further be improved. Here, the first dielectric body powder may be smaller than or equal to the second dielectric body powder, and the second dielectric body powder may be smaller than or equal to the third dielectric body powder. That is, when the average particle diameter of the first dielectric body powder is A, the average particle diameter of the second dielectric body powder is B, and the average particle diameter of the third dielectric body powder is C, the ratio A:B:C may be 10-100:100-300:300-500. For example, the ratio A:B:C may be 10:100:300 and may be 100:200:500. In addition, the dielectric body 320 may have a larger predetermined shape than powder having sizes of 1 μm to 500 μm. For example, the dielectric body 320 may be added into an insulating material 330 in an approximately rectangular shape with a predetermined thickness. At this point, the plate-like dielectric body 320 may be provided in an approximately rectangular plate shape which has respectively predetermined lengths in the horizontal direction and another direction perpendicular thereto and has a predetermined thickness in the vertical direction. Such a rectangular plate-like dielectric body 320 may have a size such as 3 μm to 5,000 μm. Preferably, the rectangular plate-like dielectric body 320 may have a length of 3 μm to 5,000 μm in at least one direction. At this point, the plate-like dielectric body 320 also may be composed of materials of a single kind, which have two or more sizes, or at least two or more kinds of materials. Of course, the dielectric body 320 may also be formed such that a powder-like first dielectric body having at least two or more sizes and a plate-like second dielectric body having at least two or more sizes are mixed. Meanwhile, the sizes of the dielectric body 320 may be larger than the thickness of the dielectric layer 300, and in this case, the dielectric body 320 may be provided in the horizontal direction, and may have a size larger than the thickness of the dielectric layer 300 in the horizontal direction.

A material having a dielectric constant of 4 or more, preferably, greater than 4, for example, a material including at least one among Ba, Ti, Nd, Bi, Zn, and Al, and for example, an oxide thereof may be used for the dielectric body 320. For example, the dielectric body 320 may include one or more among BaTiO₃, BaCO₃, TiO₂, and Al₂O₃. In addition, an additive such as Nd, Bi, and Zn may further be added. The dielectric constant may be improved by further adding an additive. Meanwhile, the dielectric body 320 may be formed with a density of 0.01% to 95%. That is, the dielectric body 320 may be added in an amount of 0.01 to 95 based on 100 of the dielectric layer 310 in which the insulating material 330 and the dielectric body 320 are mixed. At this point, the higher the density of the dielectric body 320, the higher the dielectric constant of the dielectric layer 300. Therefore, preferably, the density of the dielectric body 320 is increased to a range in which the dielectric constant can be maximally increased. In addition, preferably, the dielectric layer 320 is prepared in the same density in all the regions thereof. However, the piezoelectric body 320 may be provided such that at least one region thereof has a density of 0.01% or more. For example, when at least one region of the dielectric bodies 320 has a density of 1% and at least another region has a density of 95%, a larger value of change in electrostatic capacitance may be sensed in the region with the greater density. However, even when a region has a density of 0.01% or more, a control unit may sufficiently sense the value of change in electrostatic capacitance according to the density.

In addition, a material, the thickness of which may be changed due to a pressure change, may be used for the insulating material 330. That is, a material which can be compressed and restored may be used for the insulating material 330. For example, the insulating material 330 may include, but not limited to, at least one or more selected from the group consisting of silicone, rubber, polymer, epoxy, polyimide and liquid crystalline polymer (LCP). In addition, the insulating material 330 has a hardness of 30 or less based on rubber, and foaming rubber, gel, phorone, urethane, or the like may be used for the insulating material 330. Here, the urethane which has a dielectric constant of 4 or more and can be compressed and restored, may also be independently used without containing the dielectric body 320, and may also further improve the dielectric constant by containing the dielectric body 320. That is, the dielectric constant may be maintained at 4 or more even without containing the dielectric body 320, and may also further improve the dielectric constant by containing the dielectric body 320. In addition, the insulating material 330 may be formed of a thermoplastic resin. The thermoplastic resin may include, for example, one or more selected from the group consisting of novolac epoxy resin, phenoxy-type epoxy resin, BPA-type epoxy resin, BPF-type epoxy resin, hydrogenated BPA epoxy resin, dimer acid modified epoxy resin, urethane modified epoxy resin, rubber modified epoxy resin and DCPD-type epoxy resin. Of course, besides the above materials, the material which can be used for the dielectric layer 300 described in the first and second exemplary embodiments may be used for the insulating material 330 in accordance with a third exemplary embodiment.

Meanwhile, the dielectric layer 300 in accordance with a third exemplary embodiment may further include a material for shielding and absorbing electromagnetic waves as the first and second exemplary embodiments. The material for shielding and absorbing electromagnetic waves may have a size smaller than the dielectric body 320. Of course, the material for shielding and absorbing electromagnetic waves may have a size greater than the dielectric body 320. In addition, the material for shielding and absorbing electromagnetic waves may have a plurality of sizes larger or smaller than that of the dielectric body 320. As such, the material for shielding and absorbing electromagnetic waves is further contained in the dielectric layer 300, whereby the electromagnetic waves may be shielded or absorbed. The material for shielding and absorbing electromagnetic waves may include ferrite, alumina, or the like, and may be contained in an amount of 0.01 wt % to 50 wt % in the dielectric layer 300. That is, based on 100 wt % of the materials constituting the dielectric layer 300, 0.01 wt % to 50 wt % of the material for shielding and absorbing electromagnetic waves may be contained. When the content of the material for shielding and absorbing electromagnetic waves is less than 0.01 wt %, the electromagnetic wave shielding and absorbing characteristic may be low, and when the content exceeds 50 wt %, the compression characteristic of the dielectric layer 300 may be decreased.

As described above, in the pressure sensor in accordance with the third exemplary embodiment, the dielectric layer 300 may be formed between the first and second electrode layers 100 and 200 which are spaced apart from each other, and the dielectric layer 300 may be formed by mixing the dielectric body 320 having a dielectric constant of 4 or more, preferably, greater than 4, and the insulating material 330 which can be compressed and restored. Accordingly, the dielectric layer 300 may have a dielectric constant of 4 or more. That is, when the dielectric layer 300 is formed by mixing: the dielectric body 320 having powder of ceramic or the like with a high dielectric constant or having other shape other than the powder; and the insulating material 330, such as, polymer, rubber, silicone, phorone, foamed rubber, urethane or the like, a material having a dielectric constant of at least several to several hundred times that of air may be formed. In addition, using these materials, sufficient data may be obtained even by a minute amount of change between the first and second electrode layers 100 and 200. Thus, the resolution is improved due to the amount of change in a capacitance value, whereby a pressure sensor, the data of which is easily processed, may be manufactured. In addition, since a large change in thickness is not necessary between the first and second electrode layers 100 and 200, the thickness thereof may be minimized, and thus, the thicknesses of the pressure sensor and the pressure sensor module may be reduced. That is, in an exemplary embodiment, the strength of pressure is measured such that dielectric layer 300 is compressed, and the amount of change in electrostatic capacitance value due to the change in distance between the electrodes is measured. Since the density of dielectric body 320 increases according to compression of the insulating materials 330, the value of change in electrostatic capacitance increases due to pressure and thus, measurement of the value of change in electrostatic capacitance becomes easy. Consequently, in the exemplary embodiment, the dielectric constant of the dielectric layer 300 is not simply increased, but the dielectric body 320 having a dielectric constant is added to the compressible insulating material 330, and thus, the amount of change in electrostatic capacitance can be easily increased.

FIG. 7 is a cross-sectional view of a pressure sensor in accordance with a fourth exemplary embodiment.

Referring to FIG. 7, a pressure sensor in accordance with a fourth exemplary embodiment includes: first and second electrode layers 100 and 200 which are spaced apart from each other; a dielectric layer 300 provided between the first and second electrode layers 100 and 200; and a cutaway portion 340 formed with a predetermined width and a predetermined depth in at least one region of the dielectric layer 300. In addition, the dielectric layer 300 may include at least one among the pores 310 and dielectric body 320. By forming the cutaway portion 340, the flexible characteristic may be improved, and an amount of change due to pressure may further be increased. That is, although the amount of change due to pressure is great, the amount of change due to pressure may further be increased by forming the cutaway portion 340.

The dielectric layer 300 may be formed with predetermined widths and predetermined intervals in one direction and another direction facing the one direction. That is, the cutaway portion 340 of the dielectric layer 300 may be formed to a predetermined depth and thereby the dielectric layer 300 is divided into a plurality of unit cells with predetermined widths and intervals. At this point, the cutaway portion 340 may include a plurality of first cutaway portions formed with predetermined widths in one direction, and a plurality of second cutaway portions formed with predetermined widths in another direction perpendicular to the one direction. Accordingly, the dielectric layer 300 may be respectively divided into a plurality of unit cells having predetermined widths and depths by the plurality of first and second cutaway portions. At this point, in the dielectric layer 300, the entire thickness may be cut, or 50% to 95% of the entire thickness may also be cut. That is, in the dielectric layer 300, the entire thickness is cut or 50% to 95% of the entire thickness is cut, whereby the cutaway portion may be formed. As such, the dielectric layer 300 has a predetermined flexible characteristic by being cut. At this point, the dielectric layer 300 may be cut so as to have a size of 10 μm to 5,000 μm and intervals of 1 μm to 300 μm. That is, by means of the cutaway portion 340, a unit cell may have a size of 10 μm to 5,000 μm and intervals of 1 μm to 300 μm. Meanwhile, the first and second cutaway portions of the piezoelectric layer 300 may correspond to the intervals between the first and second electrodes 100 and 200. That is, the first cutaway portion is formed to correspond to the intervals between the first electrodes of the first electrode layer 100, and the second cutaway portion is formed to correspond to the intervals between the second electrodes of the second electrode layer 200. At this point, the intervals of the electrode layers and the intervals of the cutaway portions may be the same, or the intervals of the electrode layers may be greater than or smaller than the intervals of the cutaway portions. Meanwhile, the dielectric layer 300 may be formed by cutting the dielectric layers 300 through a method such as laser, dicing, blade cutting, or the like.

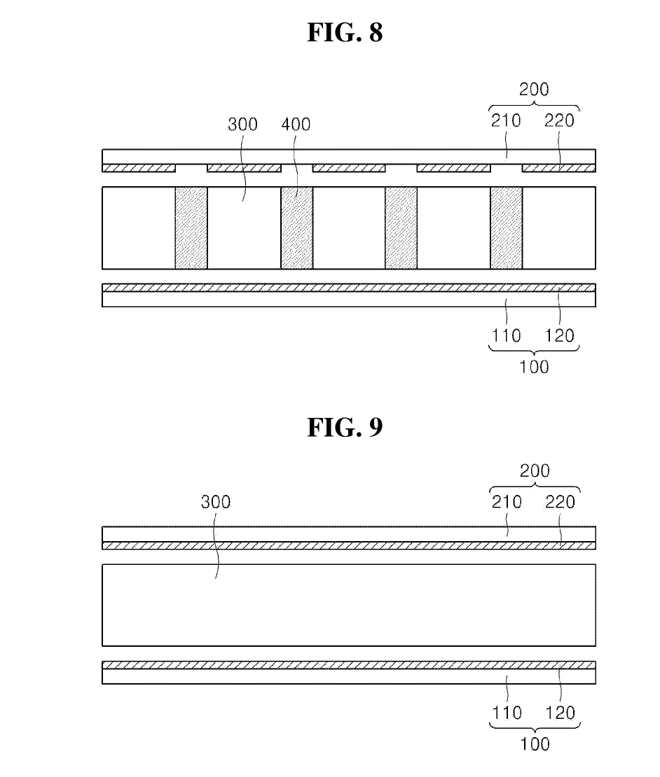

FIG. 8 is a cross-sectional view of a pressure sensor in accordance with a fifth exemplary embodiment.

Referring to FIG. 8, a pressure sensor in accordance with a fifth exemplary embodiment may include: first and second electrode layers 100 and 200 which are spaced apart from each other; a dielectric layer 300 which is provided between the first and second electrode layers 100 and 200 and has a plurality of cutaway portions 340 formed therein in one direction and another direction; and an elastic layer 400 formed in the cutaway portions 340 of the dielectric layer 300. In addition, the dielectric layer 300 may include at least one among the pores 310 and dielectric body 320. At this point, the cutaway portions 340 may be formed in the entire thickness of the dielectric layer 300 and formed in a predetermined thickness. That is, the cutaway portions 340 may be formed in a thickness of 50% to 100% of the thickness of the dielectric layer 300. Accordingly, the dielectric layer 300 may be divided into unit cells spaced apart predetermined distances from each other in one direction and another direction by the cutaway portions 340, and the elastic layer 400 may be formed between the unit cells.

The elastic layer 400 may be formed by using a polymer, silicon, or the like which have elasticity. That is, a material different from that of the dielectric layer 300 may be used for the elastic layers 400. Since the elastic layers 400 are formed, the shape of the dielectric layer 300 may be maintained, the dielectric layer 300 may have higher flexible characteristic than the fourth exemplary embodiments in which the elastic layers 400 are not formed. That is, since the dielectric layer 300 includes the cutaway portions 340, the shape of the dielectric layer 300 may also not be maintained according to cases. However, since the elastic layers 400 are formed in predetermined regions, the elastic layers 400 may support the dielectric layer 300 from therebetween, and thus, the shape of the dielectric layer 300 may be maintained. In addition, the cutaway portions 340 are formed in the dielectric layer 300, but when the elastic layers are not formed, the flexible characteristic of the piezoelectric layer 300 may be restricted. However, since the dielectric layer 300 is entirely cut and the elastic layers 400 are formed, the flexible characteristic may be improved in such a degree that the dielectric layer 300 can be roundly rolled or folded. Of course, the elastic layers 400 may also be formed so as to fill the cutaway portions 340 formed such that the cutaway portions 340 are not formed in the entire thickness of the dielectric layer 300 but are formed in a portion of the entire thickness.

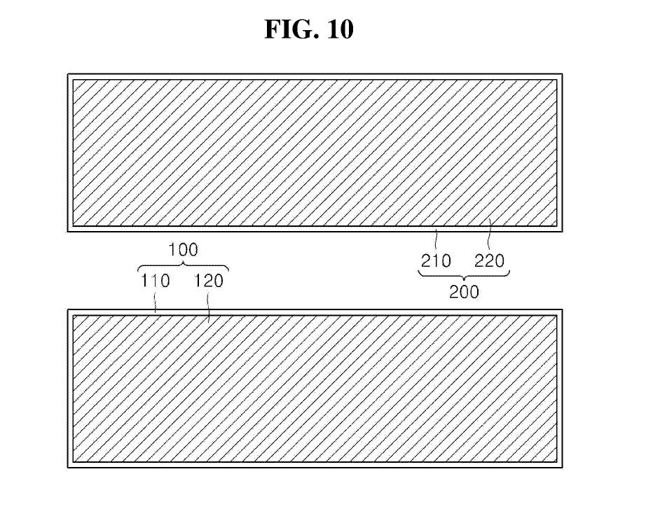

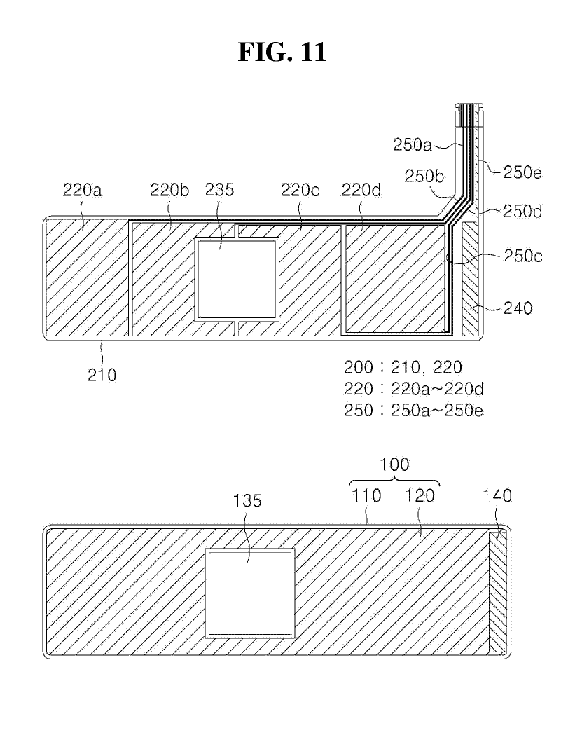

FIG. 9 is a cross-sectional view of a pressure sensor in accordance with a sixth exemplary embodiment. In addition, FIGS. 10 and 11 are schematic plan views of first and second electrode layers in accordance with other exemplary embodiments.

As illustrated in FIG. 9, a pressure sensor in accordance with a sixth exemplary embodiment includes: first and second electrode layers 100 and 200 which are spaced apart from each other; and a dielectric layer 300 provided between the first and second electrode layers 100 and 200. As illustrated in exemplary embodiments, the dielectric layer 300 may be formed of a material having a hardness of 10 or less, and may include at least any one among the plurality of pores 310 and dielectric bodies 320. Here, the first and second electrode layers 100 and 200 may include: first and second support layers 110 and 210, respectively; and first and second electrodes 120 and 220 which are formed on first and second support layers 110 and 210. That is, the pressure sensor in accordance with the sixth exemplary embodiment has the same configuration as the pressure sensor in accordance with the first exemplary embodiment described by using FIG. 1. At this point, the first and second electrodes 120 and 220 may be formed in directions facing each other, or may also be formed not facing each other. However, the first and second electrodes 120 and 220, as described in FIG. 10, may be entirely formed on the first and second support layers 110 and 210. That is, as illustrated in FIGS. 2 and 3, the first and second electrodes 120 and 220 may also be formed to have a predetermined pattern, but as illustrated in FIG. 10, may entirely be formed on the support layers 110 and 210. The first and second electrodes 100 and 200 having such a shape may be applied to a pressure sensor provided to detect a pressure in a local region. That is, in order to detect a pressure in a plurality of regions in an electronic device using a single pressure sensor, electrodes 120 and 220 which are formed in predetermined patterns as illustrated in FIGS. 2 and 3 may be used, and to detect a pressure in a local region, the electrodes 120 and 220 which are entirely formed on the support layers 110 and 210 as illustrated in FIG. 7 may be used. However, regardless of the shapes of the electrodes 120 and 220, pressure detection can be locally or entirely performed, and according to an application to be used or hardware specification, various electrode shapes and detection regions may be used.

In addition, even when the electrodes 210 and 220 entirely formed on the support layers 110 and 210, predetermined cutaway portions 320 may also be formed on the dielectric layer 300, and elastic layers 400 may also be formed in the cutaway portions 320.

Meanwhile, the pressure sensor in accordance with an exemplary embodiment may have openings 135 and 235 on predetermined regions. That is, as illustrated in FIG. 11, first and second electrode layers 100 and 200 may be formed in predetermined shapes, and openings 135 and 235 may be formed in predetermined regions of the first and second electrode layers 100 and 200. The openings 135 and 235 may be provided such that another pressure sensor or a functional part having a different function from the pressure sensor may be inserted therethrough. At this point, although not shown, also in the dielectric layer 300, openings overlapping the openings 135 and 235 formed in the first and second electrode layers 100 and 200 may be formed. Here, by using the pressure sensor, it is possible to enable another pressure sensor or a functional part inserted in the openings 130 and 230. That is, by using the pressure sensor, power may be applied to the another pressure sensor or the functioning part which are inserted into the openings 130 and 230. Alternatively, simultaneously with power applied to the pressure sensor by an application or hardware, or after a predetermined time, power may be applied to the another pressure sensor or the functioning part which are inserted into the openings 130 and 230. Meanwhile, the first and second electrodes 100 and 200 may also be formed in shapes different from each other. That is, as illustrated in FIG. 11, the first electrode layer 100 may have a first electrode 120 formed entirely on a first support layer 110, and the second electrode layer 200 may have a plurality of second electrodes 220 which are spaced a predetermined distance apart from each other on a second support layer 210. For example, the second electrodes 210 may be provided such that a first region 210a with an approximately rectangular shape, second and third regions 220b and 220c which have approximately rectangular shapes and are formed with the opening 230 therebetween, and a fourth region 220d formed in an approximately rectangular shape are spaced predetermined distances apart from each other. In addition, a first connection pattern 140 may be formed on the first support layer 110, and a second connection pattern 240 may be formed on the second support layer 210. At this point, the first connection pattern 140 is formed in contact with the first electrode 110, and the second connection pattern 240 is formed being spaced apart from the fourth region 220d. In addition, the first and second connection patterns 140 and 240 may be formed so as to partially overlapping each other. Of course, although not shown, a third connection pattern may be formed between the first and second connection patterns 140 and 240 on at least a portion of the dielectric layer 300 between the first and second electrode layers 100 and 200. That is, the third connection pattern may be formed being spaced apart from the dielectric layer 300. Accordingly, the first and second connection patterns 140 and 240 may be connected through the third connection pattern. In addition, in the second electrode layer 200, first to fourth extending patterns 250a, 250b, 250c, and 250d may respectively be formed by extending from the first to fourth regions 210a to 210d, and a fifth extending pattern 250e may be formed by extending from the second connection pattern 240. The first to fifth extending patterns 250a to 250d may extend to a connector (not shown) and be connected to a control unit or power supply unit. Accordingly, a predetermined power supply such as a ground power supply may be applied to the first connection pattern 140 through the fifth extending pattern 250e, the second connection pattern 240, and the third connection pattern. In addition, the voltage sensed by the first to fourth regions 220a to 220d may be transferred to the connector through the first to fourth extending patterns 250a to 250d. Of course, a predetermined power supply such as a driving power supply may be applied to the first to fourth regions 220a to 220d through the first to fourth extending patterns 250a to 250d.

The pressure sensors in accordance with the above exemplary embodiments may be provided in electronic devices such as smart phones and detect a touch or a pressure from a user. An electronic device provided with a pressure sensor in accordance with exemplary embodiments will be described as follows using drawings.

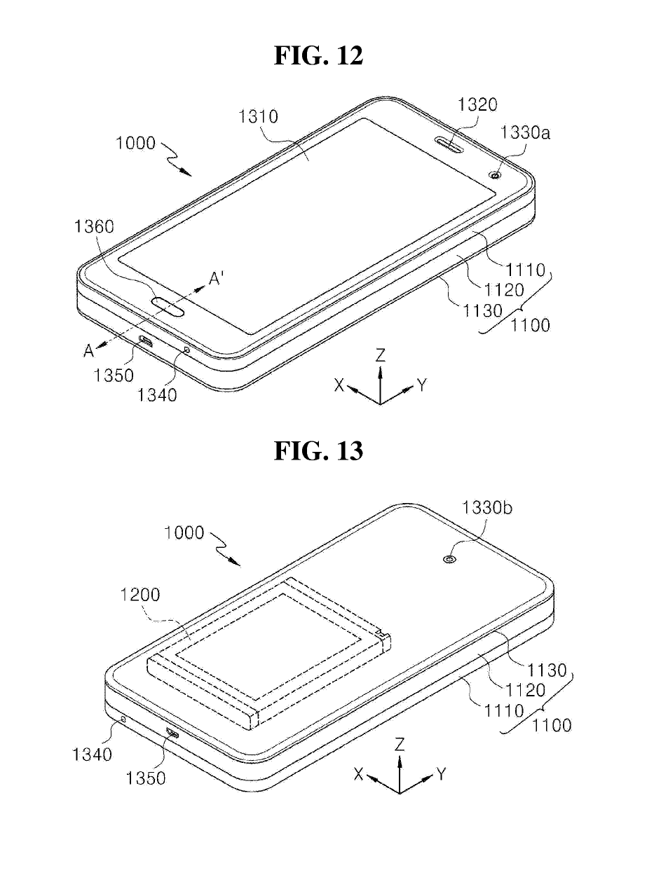

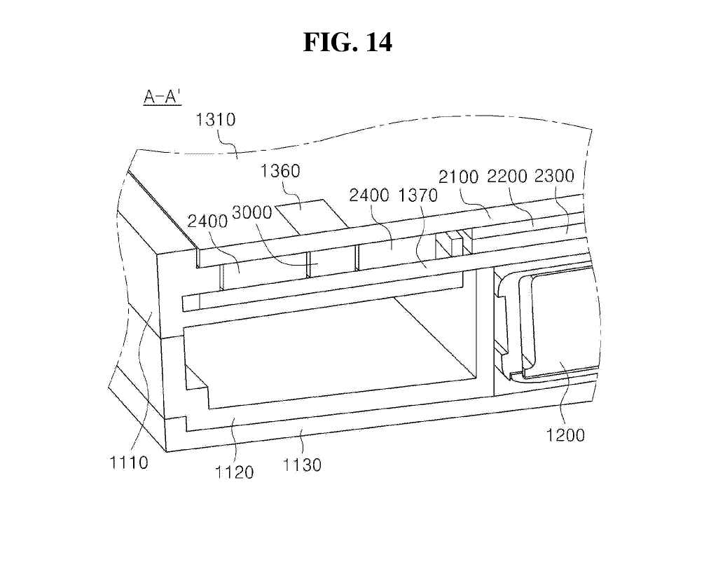

FIGS. 12 and 13 are a front perspective view and a rear perspective view of an electronic device provided with a pressure sensor in accordance with an exemplary embodiment, and FIG. 14 is a partial cross-sectional view taken along line A-A′ of FIG. 12. Here, the exemplary embodiment may be described using a mobile terminal including a smart phone as an example of an electronic device provided with a pressure sensor, and FIGS. 12 to 14 schematically illustrate main portions related to the exemplary embodiment.

Referring to FIGS. 12 to 14, an electronic device 1000 includes a case 1100 forming an outer appearance and a plurality of functional modules, circuits, and the like for performing a plurality of functions of the electronic device 1000 are provided inside the case 1100. The case 1100 may include a front case 1110, a rear case 1120, and a battery cover 1130. Here, the front case 1110 may form a portion of the upper portion and the side surface of the electronic device 1000, and the rear case 1120 may form portions of the side surface and the lower portion of the electronic device 1000. That is, at least a portion of the front case 1110 and at least a portion of the rear case 1120 may form the side surface of the electronic device 1000, and a portion of the front case 1110 may form portions of the upper surface except for a display part 1310. In addition, the battery cover 1130 may be provided to cover the battery 1200 provided on the rear case 1120. Meanwhile, the battery cover 1130 may be integrally provided or detachably provided. That is, when the battery 1200 is an integral type, the battery cover 1130 may be integrally formed, and when the battery 1200 is detachable, the battery cover 1130 may also be detachable. Of course, the front case 1110 and the rear case 1120 may also be integrally manufactured. That is, the case 1100 is formed such that the side surface and the rear surface are closed without distinction of the front case 1110 and the rear case 1120, and the battery cover 1130 may be provided to cover the rear surface of the case 1100. Such as case 1100 may have at least a portion formed through injection molding of a synthetic resin and may be formed of a metal material. That is, at least portions of the front case 1110 and the rear case 1120 may be formed of a metal material, and for example, a portion forming the side surface of the electronic device 1000 may be formed of a metal material. Of course, the battery cover 1130 may also be formed of a metal material. Metal materials used for the case 1100 may include, for example, stainless steel (STS), titanium (Ti), aluminum (Al) or the like. Meanwhile, in a space formed between the front case 1110 and the rear case 1120, various components, such as a display part such as a liquid crystal display device, a pressure sensor, a circuit board, a haptic device, may be incorporated.

In the front case 1110, a display part 1310, a sound output module 1320, a camera module 1330a, and the like may be disposed. In addition, on one surface of the front case 1110 and the rear case 1120, a microphone 1340, an interface 1350 and the like may be disposed. That is, on the upper surface of the electronic device 1000, the display part 1310, the sound output module 1320, the camera module 1330a and the like may be disposed, and on one side surface of the electronic device 1000, that is, on the lower side surface, the microphone 1340, the interface 1350, and the like may be disposed. The display part 1310 is disposed on the upper surface of the electronic device 1000 and occupies the most of the upper surface of the front case 1110. That is, the display part 1310 may be provided in an approximately rectangular shape respectively having predetermined lengths in X- and Y-directions, includes the central region of the upper surface of the electronic device 1000, and is formed on most of the upper surface of the electronic device 1000. At this point, between the outer contour of the electronic device 1000, that is, the outer contour of the front case 1110, and the display part 1310, a predetermined space which is not occupied by the display part 1310 is provided. In the X-direction, the sound output module 1320 and the camera module 1330a are provided above the display part 1310, and a user input part including a front surface input part 1360 may be provided below the display part 1310. In addition, between two edges of the display part 1310, which extend in the X-direction, and the periphery of the electronic device 1000, that is, between the display part 1310 and the electronic device 1000 in the Y-direction, a bezel region may be provided. Of course, a separate bezel region may not be provided, and the display part 1310 may be provided to extend up to the periphery of the electronic device 1000 in the Y-direction.

The display part 1310 may output visual information and receive touch information from a user. To this end, the display part 1310 may be provided with a touch input device. The touch input device may include: a window 2100 which covers the front surface of the terminal body; a display part 2200 such as a liquid crystal display device; and a first pressure sensor 2300 with which touch or pressure information of a user is input in accordance with at least one of the exemplary embodiments. In addition, the touch input device may further include a touch sensor provided between the window 2100 and the display part 2200. That is, the touch input device may include a touch sensor and a first pressure sensor 2300. For example, the touch sensor may be formed such that a plurality of electrodes are formed to be spaced apart from each other in one direction and another direction perpendicular to the one direction on a transparent plate with a predetermined thickness, and a dielectric layer is provided therebetween and may detect a touch input from the user. That is, the touch sensor may have the plurality of electrodes disposed, for example, in a lattice shape, and detect the electrostatic capacitance according to the distance between the electrodes due to the touch input of the user. Here, the touch sensor may detect coordinates in the horizontal direction of user's touch, that is, in the X- and Y-directions perpendicular each other, and the first pressure sensor 2300 may detect coordinates not only in the X- and Y-directions, but also in the vertical direction, that is, in the Z-direction. That is, the touch sensor and the first pressure sensor 2300 may simultaneously detect coordinates in the X- and Y-directions, and the first pressure sensor 2300 may further detect the coordinate in the Z-direction. As such, the touch sensor and the first pressure sensor 2300 simultaneously detects the horizontal coordinates, and the first pressure sensor 2300 detects the vertical coordinate, whereby the touch coordinate of the user may be more precisely detected.

Meanwhile, in regions besides the display part 1310 on the upper surface of the front case 1110, the sound output module 1320, the camera module 1330a, the front surface input part 1360, and the like may be provided. At this point, the sound output module 1320 and the camera module 1330a may be provided above the display part in the display part 1310, and the user interface part such as the front surface input part 1360 may be provided below the display part 1310. The front surface input part 1360 may be configured from a touch key, a push key, or the like, and a configuration is possible by using a touch sensor or a pressure sensor without the front surface input part 1360. At this point, in an inner lower portion of the front input part 1360, that is, inside the case 1100 below the front input part 1360 in the Z-direction, a function module 3000 for functions of the front input part 7360 may be provided. That is, according to a driving method of the front surface input part 1360, a functional module which performs the functions of a touch key or a push key may be provided, and a touch sensor or a pressure sensor may be provided. In addition, the front input part 1360 may include a fingerprint recognition sensor. That is, the fingerprint of the user may be recognized through the front surface input part, and whether the user is a legal user may be detected, and to this end, the function module 3000 may include a fingerprint recognition sensor. Meanwhile, in the Y-direction on one side and the other side of the front surface input part, a second pressure sensor 2400 may be provided. The second pressure sensors 2400 are provided on both sides of the front surface input part 1360 as a user input part, so that a function of detecting the user's touch input and returning to the previous screen and a setting function for screen setting of the display part 1310 may be performed. At this point, the front surface input part 1360 using the fingerprint recognition sensor may perform not only the fingerprint recognition of a user but also the function of returning to the initial screen. Meanwhile, a haptic feedback device such as a piezoelectric vibration device which contacts the display part 1310 may further be provided and thereby provide a feedback by responding to an input or a touch of the user. Such a haptic feedback device may be provided in a predetermined region of the electronic device 1000 except for the display par 1310. For example, the haptic feedback device may be provided in an outside region of the sound output module 1310, an outside region of the front surface input part 1360, a bezel region, or the like. Of course, the haptic feedback device may be provided below the display part 1310.

On the side surface of the electronic device 1000, although not shown, a power supply part and a side surface input part may further be provided. For example, the power supply part and the side surface input part may respectively be provided on two side surfaces facing each other in the Y-direction in the electronic device, and may also be provided on one side surface so as to be spaced apart from each other. The power supply part may be used when turning on or off the electronic device, and be used when enabling or disabling a screen. In addition, the side surface input part may be used to adjust the loudness or the like of a sound output from the sound output module 1320. At this point, the power supply part and the side surface input part may be configured from a touch key, a push key, or the like, and also be configured from a pressure sensor. That is, the electronic device in accordance with an exemplary embodiment may be provided with pressure sensors in a plurality of regions besides the display part 1310. For example, at least one pressure sensor may further be provided for detecting a pressure of sound output module 1320, the camera module 1330a, or the like on the upper side of the electronic device, controlling a pressure of the front input part 1360 on the lower side of the electronic device, controlling a pressure of the power supply part and side input part on the side surface of the electronic device.

Meanwhile, on the rear surface, that is, on the rear case 1120 of the electronic device 1000, as illustrated in FIG. 12, a camera module 1330b may further be mounted. The camera module 1330b may be a camera which has a capturing direction substantially opposite that of the camera module 1330a, and has pixels different from those of the camera module 1330a. A flash (not shown) may additionally be disposed adjacent to the camera module 1330b. In addition, although not shown, a fingerprint recognition sensor may be provided under the camera module 1330b. That is, the front surface input part 1360 is not provided with a fingerprint recognition sensor, and the fingerprint recognition sensor may also be provided on the rear surface of the electronic device 1000.

The battery 1200 may be provided between the rear case 1120 and the battery cover 1300, also be fixed, or also be detachably provided. At this point, the rear case 1120 may have a recessed region corresponding to a region in which the battery 1200 is inserted, and may be provided such that after the battery 1200 is mounted, the battery cover 1200 covers the battery 1200 and the rear case 1120.

In addition, as illustrated in FIG. 14, a bracket 1370 is provided inside the electronic device 1000 between the display part 1310 and the rear case 1130, and the window 2100, the display section 2200, and the pressure sensor 2300 may be provided above the bracket 1370. That is, above the bracket 1370 of the display part 1310, a touch input device in accordance with an exemplary embodiment may be provided, and the bracket 1370 supports the touch input device. In addition, the bracket 1370 may extend to a region besides the display part 1310. That is, as illustrated in FIG. 14, the bracket 1370 may extend to a region in which the front surface input part 1360 and the like are formed. In addition, at least a portion of the bracket 1370 may be supported by a portion of the front case 1110. For example, the bracket 1370 extending outside the display part 1310 may be supported by an extension part extending from the front case 1110. In addition, a separation wall with a predetermined height may also be formed on the bracket 1370 in a boundary region between the display part 1310 and the outside thereof. The bracket 1370 may support the pressure sensor 2400 and the functional module 3000 such as the fingerprint recognition sensor. In addition, although not shown, there may be provided, on the bracket 1370, a printed circuit board (PCB) or a flexible printed circuit board (FPCB) provided with at least one driving means for supplying power to the functional module 3000 such as the pressure sensors 2300 and 2400 and the fingerprint recognition sensor, receiving signals output therefrom, and detecting the signals.

As described above, at least one pressure sensor in accordance with exemplary embodiments may be provided in a predetermined region in the electronic device. For example, as described above, the pressure sensors may be provided respectively in the display part 1310 and a user input part, and also be provided in any one thereamong. However, at least one or more of the pressure sensors may be provided in a predetermined region in the electronic device. As such, various examples in accordance with exemplary embodiments in which pressure sensors may be provided in a plurality of regions will be described as follows.

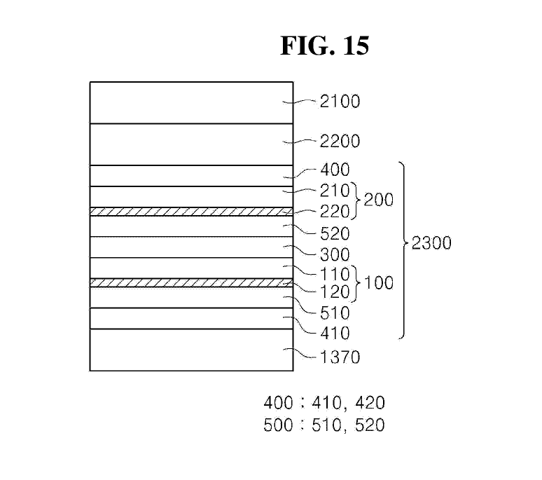

FIG. 15 is a cross-sectional view of an electronic device in accordance with a second exemplary embodiment, and is a cross-sectional view of a touch input device provided in the display part 1310.

Referring to FIG. 15, an electronic device in accordance with the second exemplary embodiment includes a window 2100, a display section 2200, a pressure sensor 2300, and a bracket 1370.

The window 2100 is provided on the display section 2200 and is supported by at least a portion of a front case 1110. In addition, the window 2100 forms the upper surface of the electronic device and is to be in contact with an object such as a finger and a stylus pen. The window 2100 may be formed of a transparent material, for example, may be manufactured by using an acryl resin, glass, or the like. Meanwhile, the window 2100 may be formed not only on the display part 1310 but also on the upper surface of the electronic device 1000 outside the display part 1310. That is, the window 2100 may be formed so as to cover the upper surface of the electronic device 1000.

The display section 2200 displays an image to a user through the window 2100. The display section 2200 may include a liquid crystal display (LCD) panel, an organic light-emitting display (OLED) panel, or the like. When the display section 2200 is a liquid crystal display panel, a backlight unit (not shown) may be provided below the display section 2200. The backlight unit may include a reflective sheet, a light guide plate, an optical sheet, and a light source. A light-emitting diode (LED) may be used as the light source. At this point, the light source may be provided under an optical structure in which the reflective sheet, the light guide plate, and the optical sheet are stacked, or may also be provided on a side surface. A liquid crystal material of the liquid crystal display panel reacts with the light source of the backlight unit and outputs a character or an image in response to an input signal. Meanwhile, a light-blocking tape (not shown) is attached between the display section 2200 and the backlight unit and blocks the light leakage. The light-blocking tape may be configured in a form in which an adhesive is applied on both side surfaces of a polyethlene film. The display section 2200 and the backlight unit are adhered to the adhesive of the light-blocking tape, and the light from the backlight unit is prevented from leaking to the outside of the display section 2200 by the polyethylene film inserted in the light-blocking tape. Meanwhile, when the backlight unit is provided, the pressure sensor 2300 may also be provided under the backlight unit, and also be provided between the display section 2200 and the backlight unit.

The pressure sensor 2300 may include: first and second electrode layers 100 and 200; and a dielectric layer 300 provided between the first and second electrode layers 100 and 200. The first and second electrode layers 100 and 200 may include: first and second support layers 110 and 210; and first and second electrodes 120 and 220 which are respectively formed on the first and second support layers 110 and 210 and has at least any one among the shapes described by using FIGS. 1 to 9. At this point, the first and second electrodes 120 and 220 may be provided so as to face each other with the dielectric layer 300 disposed therebetween. However, as illustrated in FIG. 15, the first and second electrodes 120 and 220 may be formed such that any one thereof faces the dielectric layer 300 and the other does not face the dielectric layer 300. That is, the first electrode layer 100 may be formed such that the first electrode 120 is formed under a first support layer 110 and does not face the dielectric layer 300, and the second electrode layer 200 may be formed such that the second electrode 220 is formed under a second support layer 210 and faces the dielectric layer 300. In other words, upwardly from the bottom side, the first electrode 120, the first support layer 110, the dielectric layer 300, the second electrode 220, and the second support layer 210 are formed in this order. In addition, the pressure sensor 2300 may have adhesive layers 410, 420; 400 on the lowermost layer and the uppermost layer. The adhesive layers 410 and 420 may be provided for adhering and fixing the pressure sensor 2300 between the display section 2200 and the bracket 1370. A double-sided adhesive tape, an adhesive tape, an adhesive, or the like may be used for the adhesive layers 410 and 420. In addition, a first insulating layer 510 may be provided between the first electrode layer 100 and the adhesive layer 410, and a second insulating layer 520 may be provided between the dielectric layer 300 and the second electrode 220. The insulating layers 510, 520; 500 may be formed by using a material having an elastic force and a restoring force. For example, the insulating layers 510 and 520 may be formed by using silicone, rubber, gel, a teflon tape, urethane, or the like which has a hardness of 30 or less. In addition, a plurality of pores may be formed in the insulating layers 510 and 520. The pores may have sizes of 1 μm to 500 μm and may be formed in a porosity of 10% to 95%. The plurality of pores are formed in the insulating layers 510 and 520, whereby the elastic force and the restoring force of the insulating layers 510 and 520 may further be improved. Here, the first and second support layers 110 and 210 may respectively be formed in thicknesses of 50 μm to 150 μm, the first and second electrodes 120 and 220 may respectively be formed in thicknesses of 1 μm to 500 μm, and the dielectric layer 300 may be formed in a thickness of 10 μm to 5000 μm. That is, the dielectric layer 300 may be formed to be the same as or thicker than the first and second electrode layers 100 and 200, and the first and second electrode layers 100 and 200 may be formed in the same thickness. However, the first and second electrode layers 100 and 200 may be formed in thicknesses different from each other. For example, the second electrode layer 200 may be formed in a smaller thickness than the first electrode layer 100. In addition, the first and second insulating layers 510 and 520 may respectively be formed in thicknesses of 3 μm to 500 μm, and the first and second adhesive layers 410 and 420 may respectively be formed in thicknesses of 3 μm to 1,000 μm. At this point, the first and second insulating layers 510 and 520 may be formed in the same thickness, and the first and second adhesive layers 410 and 420 may be formed in the same thickness. However, the insulating layers 510 and 520 are formed in thicknesses different from each other, and the first and second adhesive layers 410 and 420 may be formed in thicknesses different from each other. For example, the first adhesive layer 410 may be formed thicker than the second adhesive layer 420.

As illustrated in FIG. 14, the bracket 1370 is provided over the rear case 1120. The bracket 1370 supports the touch sensor, the display section 2200, and the pressure sensor 2300, which are provided over the bracket, and prevents the pressing force of an object from being scattered. Such a bracket 1370 may be formed of a material the shape of which is not deformed. That is, the bracket 1370 prevents the scattering of the pressing force of an object, and supports the touch sensor, the display section 2200, and the pressure sensor 2300, and may therefore be formed of a material the shape of which is not deformed by a pressure. At this point, the bracket 1370 may be formed of a conductive material or an insulating material. In addition, the bracket 1370 may be formed in a structure in which an edge or the entire portion thereof is bent, that is, in a bent structure. As such, by providing the bracket 1370, the pressing force of an object is not scattered but concentrated, and thus, a touch region may be more precisely detected.

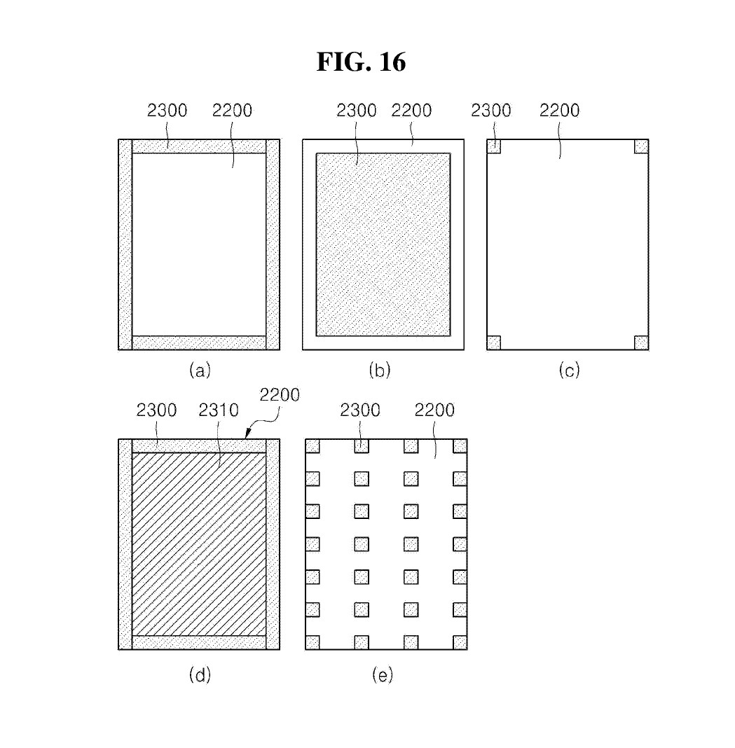

Meanwhile, the pressure sensor may be formed on the entire region under the display section 2200 and may also be formed on at least a portion under the display section 2200. Such a disposition form of the pressure sensor is illustrated in FIG. 16. FIG. 16 is a schematic plan view illustrating a disposition form of a pressure sensor in an electronic device in accordance with a second exemplary embodiment, and illustrates a disposition form of a pressure sensor 2300 with respect to a display section 2200.

As illustrated in (a) of FIG. 16, pressure sensors 2300 may be provided along the periphery of the display section 2200. At this point, the pressure sensor 2300 may be provided in predetermined widths from the periphery, that is, from the edge, of the approximately rectangular display section 2200, and in predetermined lengths. That is, pressure sensors 2300 with a predetermined width may be provided along two long sides of the display section 2200, and pressure sensors 2300 with a predetermined width may be provided along two short sides of the display section 2200. Accordingly, four pressure sensors 2300 may be provided along the periphery of the display section 2200, or one pressure sensor 2300 may also be provided along the shape of the periphery of the display section 2200.

As illustrated in (b) of FIG. 16, the pressure sensor 2300 may be provided in regions except for a predetermined width of the periphery of the display section 2200.

As illustrated in (c) of FIG. 16, the pressure sensors 2300 may be provided in regions at which two adjacent sides of the display section 2200 meet, that is, in corner regions. That is, the pressure sensors 2300 may be provided in four corner regions of the display section 2200.

As illustrated in (d) of FIG. 16, the pressure sensors 2300 are provided in the peripheral regions of the display section 2200, and a filling member 2310 such as a double-sided tape may be provided in the remaining region in which the pressure sensors 2300 are not provided.

As illustrated in (e) of FIG. 16, a plurality of pressure sensors 2300 may be provided at approximately regular intervals under the display section 2200.

Of course, in (a), (c), and (d) of FIG. 16, the filling member 2310 such as a double-sided tape may be provided in regions in which the pressure sensors 2300 are not provided.

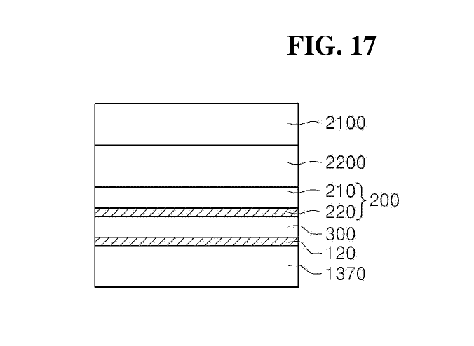

Meanwhile, any one of the first and second electrode layers 100 and 200 of the exemplary embodiment may be provided on the bracket 1370. That is, the bracket 1370 may function as the first and second electrode layers 100 and 200. In this case, a first electrode 120 or a second electrode 220 may be formed on the bracket 1370. Accordingly, the bracket 1370 may be used as a support layer for the first electrode layer 100 or the second electrode layer 200. FIG. 17 illustrates an electronic device provided with a pressure sensor in accordance with a third exemplary embodiment. FIG. 17 illustrates a case in which a first electrode 120 is formed on a bracket 1370. At this point, although not shown, a touch sensor may further be provided between a window 2100 and a display section 2200.

The bracket 1370 may be used as a first electrode layer. That is, the bracket 1370 may be used as a ground electrode. As such, in order to be used as a first electrode layer, that is, as a ground electrode, the bracket 1370 may be formed of an insulating material, and a first electrode 120 may be formed on the bracket 1370. Such a first electrode 120 may be arranged in one direction so as to have predetermined width and interval, and also be formed in a predetermined pattern. In addition, the first electrode 120 may entirely be formed on the bracket 1370. At this point, the first electrode 120 on the bracket 1370 may be formed so as to at least partially overlap a second electrode 220 of a second electrode layer 200. That is, the first and second electrodes 120 and 220 may be formed to overlap each other such that electrostatic capacitance is changed between the first electrode 120 and the second electrode 220 according to the distance between the first electrode 120 and the second electrode 220. Meanwhile, the first electrode 120 formed on the bracket 1370 may be formed of a transparent conductive material. However, the first electrode 120 may also be formed of an opaque conductive material such as copper, silver, gold, or the like. A ground potential may be applied to such a bracket 1370 through the first electrode 120. That is, a signal with a predetermined potential may be applied through the second electrode layer 200, and a ground potential may be applied through the bracket 1370. Thus, due to a touch of an object, the distance between the second electrode layer 200 and the bracket 1370 becomes smaller than a reference distance, and thus, electrostatic capacitance between the second electrode layer 200 and the bracket 1370 may be changed. Meanwhile, a conductive tape or a conductive adhesive may be formed on at least a portion of the upper surface of the bracket 1370, and through this, a ground potential may be supplied to the first electrode 120 formed on the bracket 1370. In addition, when a first support layer 110 is formed on the bracket 1370, and the first electrode 120 is formed thereon, a ground potential may be applied to the first electrode through the bracket 1370. To this end, a conductive line is formed on at least a portion of the bracket 1370, and a vertical penetration via hole, in a portion of which a conductive material is embedded, may be formed and thereby be connected to a conductive line of the bracket 1370.

Meanwhile, in the above exemplary embodiments, cases are described in which the pressure sensors 2300 are provided between the display section 2200 and the bracket 1370. However, the pressure sensors 2300 may also be provided between the window 2100 and the display section 2200, and also be provided between the display section 2200 and the backlight unit.

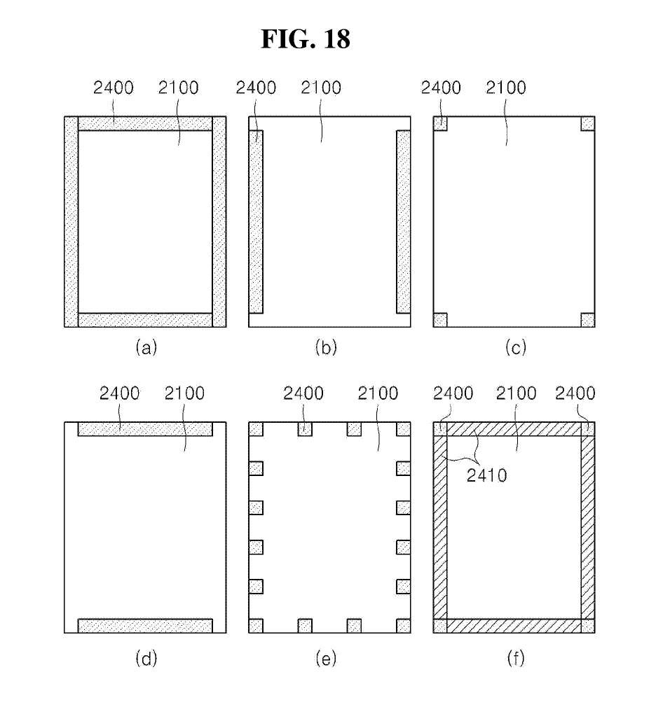

In addition, the pressure sensors may also be provided in a region besides the display part 1310. At this point, at least one pressure sensor may be provided in a region besides the display part 1310, and such a disposition form is illustrated in FIG. 18. FIG. 18 is a schematic plan view illustrating a disposition form of a pressure sensor in an electronic device in accordance with a fourth exemplary embodiment, and illustrates a disposition form of a pressure sensor 2400 with respect to a window 2100.

As illustrated in (a) of FIG. 18, pressure sensors 2400 may be provided along the periphery of the window 2100. At this point, the pressure sensors 2400 may be provided in predetermined widths from the periphery of the approximately rectangular window 2100, that is, from the edge, and in predetermined lengths. That is, pressure sensors 2400 with a predetermined width may be provided along two long sides of the window 2100, and pressure sensors 2400 with a predetermined width may be provided along two short sides of the window 2100. In other words, the pressure sensors 2400 may be provided in a region other than the display part 1310, that is, in lower and upper-side regions of the display part 1310 and in a bezel region. At this point, four pressure sensors 2400 may be provided along the periphery of the window 2100, and one pressure sensor may also be provided along the shape of the periphery of the window 2100.

As illustrated in (b) of FIG. 18, pressure sensors 2400 may be provided along the long-side edges of the window 2100. That is, the pressure sensors 2400 may be provided in a region between the edges of the display part 1310 and the periphery of an electronic device 1000, that is, in a bezel region.

As illustrated in (c) of FIG. 18, pressure sensors 2400 may be provided in regions at which two adjacent sides of the window 2100 meet, that is, in corner regions. That is, the pressure sensors 2400 may be provided in four corner regions of the window 2100.

As illustrated in (d) of FIG. 18, pressure sensors 2400 may be provided on short-side edges of the window 2100.

As illustrated in (e) of FIG. 18, a plurality of pressure sensors 2400 may be provided on short-side and long-side edges of the window 2100 so as to be spaced a predetermined distance apart from each other. At this point, the plurality of pressure sensors 2400 may be provided at approximately regular intervals.

As illustrated in (f) of FIG. 18, pressure sensors 2400 may be respectively provided on four corner regions of a window 2100, and filling members 2410 such as adhesive tapes are provided in a region between the pressure sensors 2400, that is, in long-side and short-side edge regions.

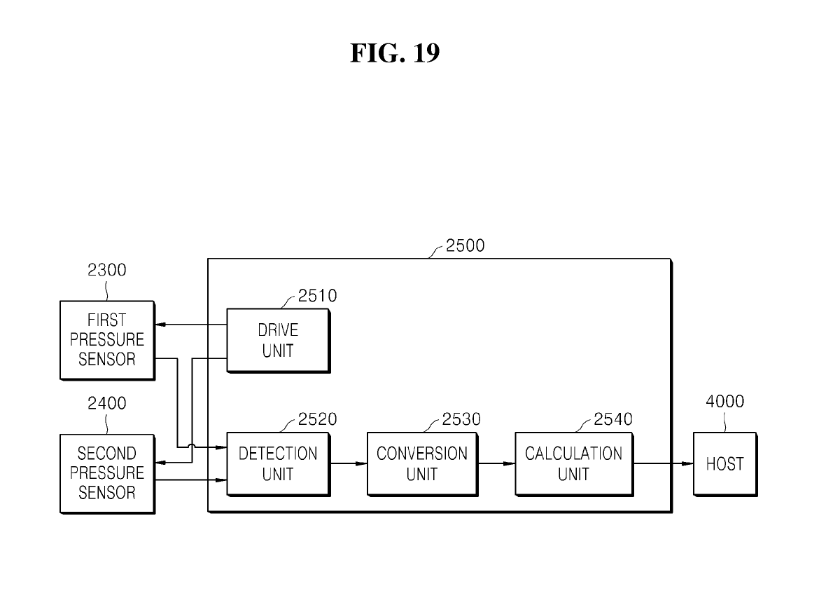

FIG. 19 is a control configuration diagram of a pressure sensor in accordance with an exemplary embodiment, and is a control configuration diagram including first and second pressure sensors 2300 and 2400.

Referring to FIG. 19, the control configuration of a pressure sensor in accordance with an exemplary embodiment may include a control unit 2500 which controls the operation of at least any one of a first pressure sensor 2300 and a second pressure sensor 2400. The control unit 2500 may include a driving unit 2510, a detection unit 2520, a conversion unit 2530, and a calculation unit 2540. At this point, the control unit 2500 including the driving unit 2510, the detection unit 2520, the conversion unit 2530, and the calculation unit 2540 may be provided as one integrated circuit (IC). Accordingly, at least one output of the pressure sensors 2300 and 2400 may be processed by using one integrated circuit (IC).

The driving unit 2510 applies a driving signal to at least one pressure sensor 2300 and 2400. That is, the driving unit 2510 may apply a driving signal to the first pressure sensor 2300 and the second pressure sensor 2400, or apply a driving signal to the first pressure sensor 2300 or the second pressure sensor 2400. To this end, the driving unit 2510 may include: a first driving unit for driving the first pressure sensor 2300; and a second driving unit for driving the second pressure sensor 2400. However, the driving unit 2510 may be configured as one unit and may apply a driving signal to the first and second pressure sensors 2300 and 2400. That is, the single driving unit 2510 may apply a driving signal to each of the first and second pressure sensors 2300 and 2400. When the first and second pressure sensors 2300 and 2400 are configured in plurality, the driving unit 2510 may apply a driving signal to the plurality of pressure sensors 2300 and 2400. In addition, the driving signal from the driving unit 2510 may be applied to any one of the first and second electrodes 120 and 220 constituting the first and second pressure sensors 2300 and 2400. Of course, the driving unit 2510 may also apply a predetermined driving signal to the second electrode 220. At this point, the driving signals applied to the first and second pressure sensors 2300 and 2400 may be the same as or different from each other. The driving signal may be a square wave, a sine wave, a triangle wave, or the like which has predetermined period and amplitude, and may be sequentially applied to each of the plurality of first electrodes 220. Of course, the driving unit 2510 may apply a driving signal simultaneously to the plurality of first electrodes 120 or also selectively apply the driving signal to only a portion among the plurality of first electrodes 120.

The detection unit 2520 detects output signals of the pressure sensors 2300 and 2400. That is, the detection unit 2520 detects electrostatic capacitance from the plurality of first electrodes 120. When a predetermined signal is applied to the second electrode 220, and a ground potential is applied to the first electrode 120 facing the second electrode, all the distance between the first and second electrodes 120 and 220 are the same and thereby have the same electrostatic capacitance. However, when the distance between the first and second electrodes 120 and 220 decreases by user's touch in at least one region, the electrostatic capacitance between the first and second electrodes becomes larger than in other regions. Accordingly, the detection unit 2520 detects a change in the electrostatic capacitance between the first and second electrodes 120 and 220 of the pressure sensors 2300 and 2400, and thereby detects an input. Here, the detection unit 2520 may include first and second detection sections for detecting the electrostatic capacitance of the first and second pressure sensors 2300 and 2400, respectively. However, the single detection unit 2520 may detect the electrostatic capacitance of all the first and second pressure sensors 2300 and 2400, and to this end, the detection unit 2520 may sequentially detect the electrostatic capacitance of the first and second pressure sensors 2300 and 2400. As such, the detection unit 2520 may detect the electrostatic capacitance of the first and second pressure sensors 2300 and 2400 and detect a touched region and the pressure of the region. For example, when a user touches with a finger, the center of the finger touches a region, and thus, there may be a central region to which the highest pressure is transferred and a peripheral region to which a pressure smaller than the highest pressure is transferred. The central region receives the largest touch pressure of a user, and thus, the distance between the first and second electrodes is small, and in the peripheral region, the distance between the first and second electrodes increases, and thus, the electrostatic capacitance of the central region is greater than that of the peripheral region. Accordingly, by detecting and comparing the electrostatic capacitance from a plurality of regions, the central region to which the highest pressure is transferred, and the peripheral region to which a pressure smaller than the highest pressure is transferred may be detected, and consequently, a region to be touched by the user may be determined and detected as the central region. Of course, the region which has not been touched by the user has lower initial electrostatic capacitance than the peripheral region. Meanwhile, such a detection unit 2520 may include a plurality of C-V converters (not shown) provided with at least one calculation amplifier and at least one capacitor, and the plurality of C-V converters may respectively be connected to the plurality of first electrodes of the first and second pressure sensors 2300 and 2400. The plurality of C-V converters may convert the electrostatic capacitance into a voltage signal and output an analog signal, and to this end, each of the plurality of C-V converters may include an integration circuit which integrates the electrostatic capacitance. The integration circuit may integrate the electrostatic capacitance, convert the capacitance into a predetermined voltage, and output the voltage. Meanwhile, when a driving signal is sequentially applied to the plurality of second electrodes from the driving unit 2510, since the electrostatic capacitance may be detected from the plurality of first electrodes, the C-V converters of the number of the plurality of first electrodes may be provided.

The conversion unit 2530 converts the analog signal output from the detection unit 2520 into a digital signal and generates a detection signal. For example, the conversion unit 2530 may include: a time-to-digital converter (TDC) circuit which measures the time until the analog signal output from the detection unit 2520 reaches a predetermined reference voltage level and converts the time into a detection signal, as a digital signal; or an analog-to-digital (ADC) circuit which measures the amount of change in the level of the analog signal output from the detection unit 2520 for a predetermined time, and converts the amount into a detection signal, as a digital signal.

The calculation unit 2540 determines the touch pressure applied to the first and second pressure sensors 2300 and 2400 using the detection signal. The number, the coordinates, and the pressure of the touch input applied to the first and second pressure sensors 2300 and 2400 may be determined by using the detection signal. The detection signal which serves as a base for the calculation unit 2540 to determine the touch input may be the data in which the change in the electrostatic capacitance is digitized, and in particular, the data which indicates the difference in the electrostatic capacitance between the case in which a touch has not occurred and the case in which touch has occurred.

As such, touch inputs to the first and second pressure sensors 2300 and 2400 may be determined by using the control unit 2500, and this may be transmitted to, for example, a main control unit of a host 4000 of an electronic device or the like. That is, the control unit 2500 generates X- and Y-coordinate data and Z-pressure data using the signal input from the pressure sensors 2300 and 2400 by using the detection unit 2520, the conversion unit 2530, the calculation unit 2540, etc. The X- and Y-coordinate data and Z-pressure data, which are generated as such, are transmitted to the host 4000, and the host 4000 detects, using, for example, a main controller, the touch and the pressure of the corresponding portion using the X- and Y-coordinate data and Z-pressure data.

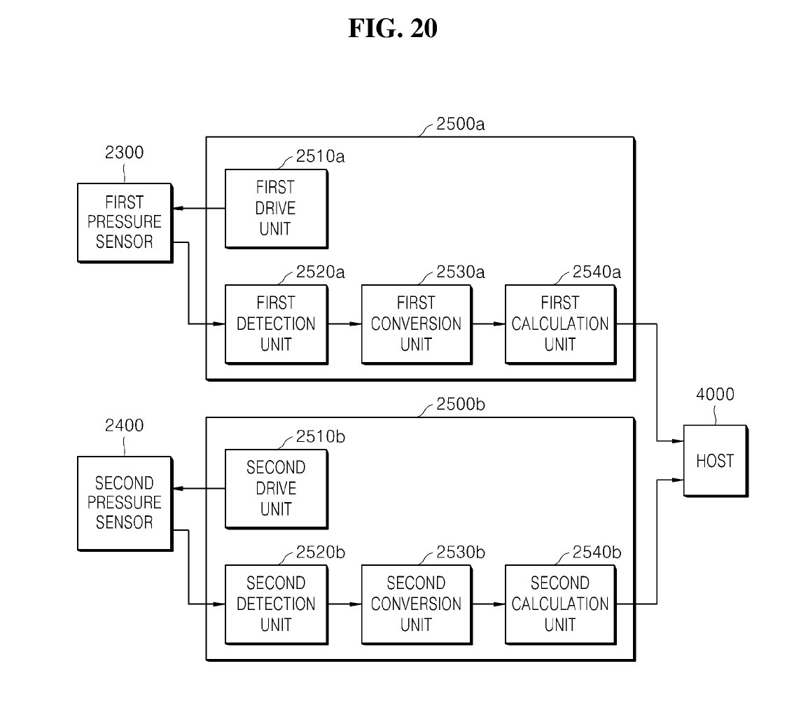

In addition, the control unit 2500 may include: a first control unit 2500a which processes the output of the first pressure sensor 2300; and a second control unit 2500b which processes the output of the second pressure sensor 2400. That is, FIG. 16 illustrates a single control unit 2500 which processes the outputs from the first and second pressure sensors 2300 and 2400, but as illustrated in FIG. 20, the control unit 2500 may include first and second control units 2500a and 2500b which respectively process the outputs of the first and second pressure sensors 2300 and 2400. Here, the first control unit 2500a may include a first drive part 2510a, a first detection unit 2520a, a first conversion unit 2530a and a first calculation unit 2540a, and the second control unit 2500a may include a second drive part 2510b, a second detection unit 2520b, a second conversion unit 2530b and a second calculation unit 2540b. Meanwhile, the first and second control units 2500a and 2500b may be implemented in integrated circuits (IC) different from each other. Accordingly, in order to process the outputs from the first and second pressure sensors 2300 and 2400, two integrated circuits may be required. However, the first and second control units 2500a and 2500b may also be implemented in respective integrated circuits (IC) different from each other. Detailed description on the configurations and functions of these first and second control units 2500a and 2500b will not be provided because the outputs from the first and second pressure sensors 2300 and 2400 are respectively divided and processed by the first and second control units, which is the same as described above using FIG. 18.

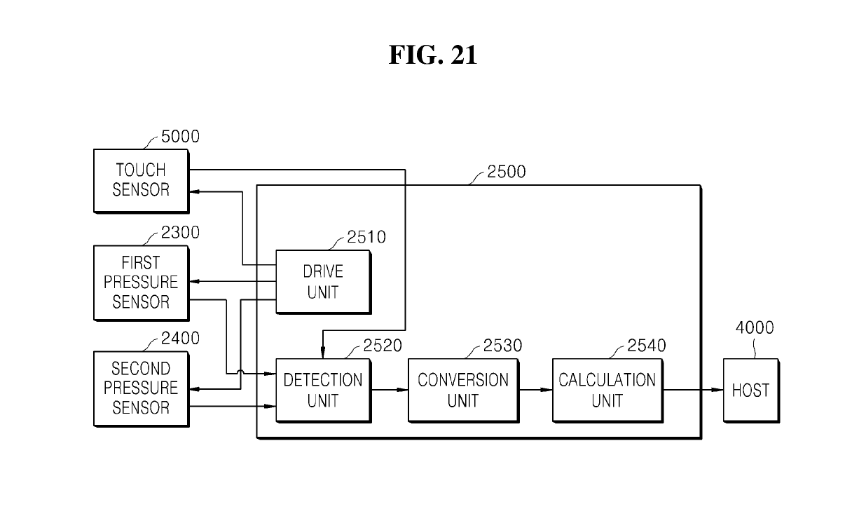

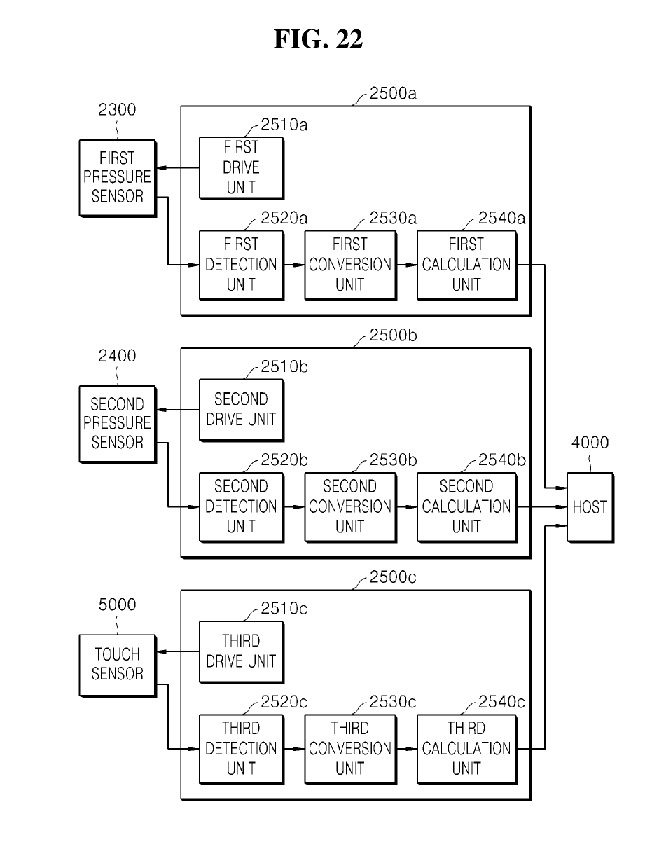

Meanwhile, the electronic device may also be further provided with a touch sensor besides at least one touch sensor of the first and second pressure sensors 2300 and 2400. In this case, the operation of the touch sensors may be performed by a single control unit 2500 as illustrated in FIG. 21. That is, the single control unit 2500 may control the at least one of the first and second pressure sensors 2300 and 2400 and the single touch sensor 5000. In addition, when the touch sensor 5000 is further provided, as illustrated in FIG. 22, besides the first and second control units 2500a and 2500b for controlling the first and second pressure sensors 2300 and 2400, a third control unit 2500c may further be provided. That is, in order to respectively control the first and second pressure sensors 2300 and 2400 and the touch sensor 5000, the plurality of control units may be provided.

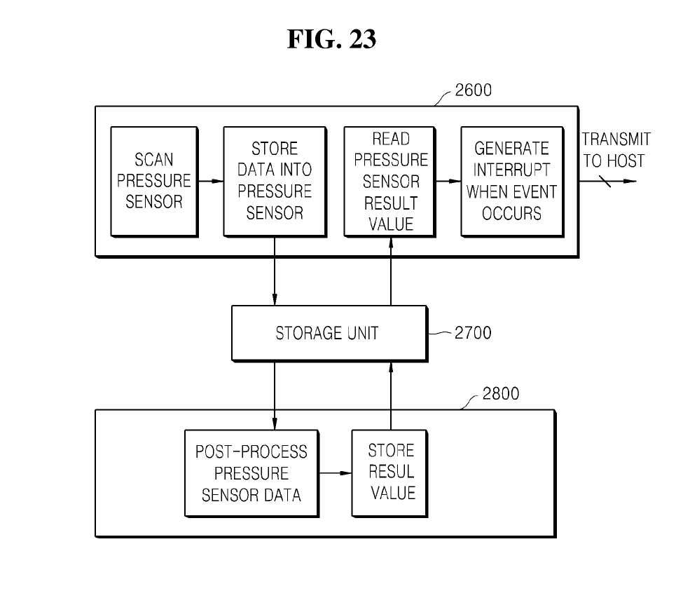

FIG. 23 is a bock diagram for describing a data processing method of a pressure sensor in accordance with another exemplary embodiment.

As illustrated in FIG. 23, in order to process the data of a pressure sensor in accordance with another exemplary embodiment, a first control unit 2600, a storage unit 2700, and a second control unit 2800 may be provided. Such a configuration may be implemented on the same IC, or also be implemented on different ICs. In addition, the data processing of the exemplary embodiment may be performed by cooperation of the first control unit 2600 and the second control unit 2800. Here, the first and second control units 2600 and 2800 may be provided to process the data of respective pressure sensors. In addition, any one (for example, the first control unit) of the first and second control units 2600 and 2800 may be the control unit for controlling a touch sensor and the other one (for example, the second control unit) may be the control unit for controlling the pressure sensors. In this case, the control unit for controlling the touch sensor may simultaneously control the touch sensor and the pressure sensor. In addition, the storage unit 2700 serves as a data transmission path of the first control unit 2600 and the second control unit 2800 and functions to store the data of the first and second control parts 2600 and 2800.

As illustrated in FIG. 23, the first control unit 2600 scans the pressure sensors and stores the raw data of the pressure sensors into the storage unit 2700. The second control part 2800 receives data from the storage unit 2700, processes the pressure sensor data, and stores the result values into the storage unit 2700. The result values stored into the storage unit 2700 may include data such as Z-axis, states, etc. The first control unit 2600 reads the result value of the pressure sensor from the storage unit 2700, and then generates and transmits, to a host, an interrupt when an event occurs.

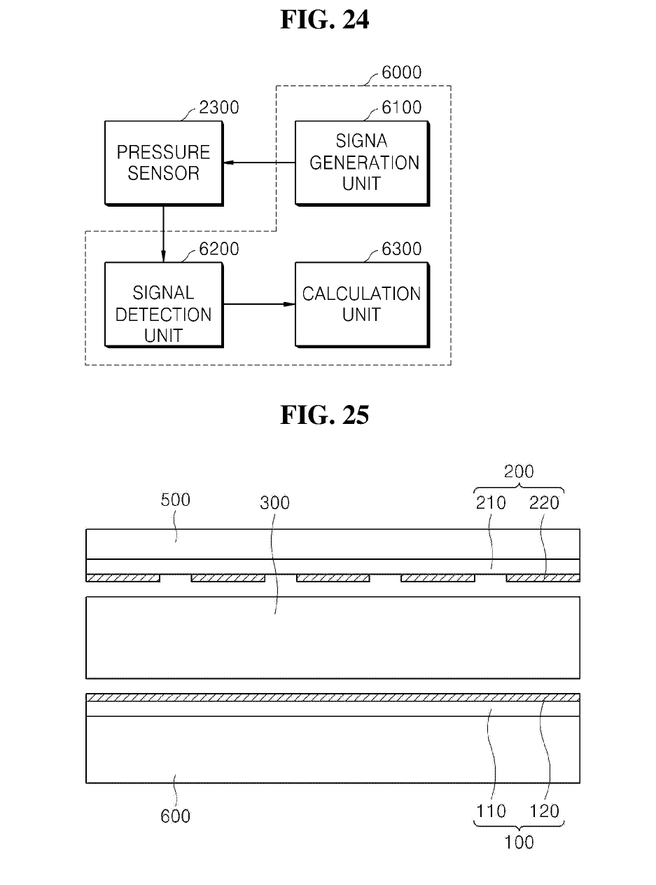

Meanwhile, as described above using FIGS. 12 to 14, the front surface input part 1360 of the electronic device 1000 may be configured from a fingerprint recognition sensor, and a pressure sensor in accordance with an exemplary embodiment may be used for the fingerprint recognition sensor. FIG. 24 is a configuration diagram of a fingerprint recognition sensor employing a pressure sensor in accordance with exemplary embodiments. In addition, FIG. 25 is a cross-sectional view of a pressure sensor in accordance with another exemplary embodiment.

Referring to FIG. 24, a fingerprint recognition sensor employing a pressure sensor in accordance with exemplary embodiments may include: a pressure sensor 2300; and a fingerprint detection unit 6000 which is electrically connected to the pressure sensor 2300 and detects a fingerprint. In addition, the fingerprint detection unit 6000 may include a signal generation unit 6100, a signal detection unit 6200, a calculation unit 6300, and the like.

Meanwhile, as illustrated in FIG. 25, the pressure sensor 2300 may further be provided with a protective layer 500 as a protective coating for the surface on which a finger is placed. The protective layer 500 may be manufactured by using urethane or another plastic which can function as a protective coating. The protective layer 500 is adhered to a second electrode layer 200 by using an adhesive. In addition, the pressure sensor 2300 may further include a support layer 600 which can be used as a support inside the pressure sensor 2300. The support layer 600 may be manufactured by using teflon or the like. Of course, instead of teflon, another type of supporting materials may be used for the support layer 600. The support layer 600 is adhered to a first electrode layer 100 by using an adhesive. Meanwhile, the pressure sensor 2300 of an exemplary embodiment may be provided with: a dielectric layer 300 divided into unit cells spaced apart predetermined distances from each other in one direction and another direction by cutaway portions 320; and an elastic layer 400 formed in the cutaway portions 320. In this case, it is desirable that the formed elastic layer 400 prevent respective vibrations from affecting each other.

The fingerprint detection unit 6000 may be connected to each of the first and second electrodes 110 and 210 which are provided on and under the dielectric layer 300 of the pressure sensor 2300. The fingerprint part 6000 may generate an ultrasonic signal by vertically vibrating the dielectric layer 300 by applying, to the first and second electrodes 110 and 210, a voltage having a resonant frequency of an ultrasonic band.

The signal generation unit 6100 is electrically connected to the plurality of first and second electrodes 110 and 210 which are included in the pressure sensor 2300, and applies, to each electrode, an alternating current voltage having a predetermined frequency. While the dielectric layer 300 of the pressure sensor 2300 is vertically vibrated by the alternating current voltage applied to the electrodes, an ultrasonic signal having a predetermined resonant frequency, such as 10 MHz, is emitted to the outside.

A specific object may contact one surface on the pressure sensor 2300, for example, one surface of the protective layer 500. When the object contacting the one surface of the protective layer 500 is a human finger including a fingerprint, the reflective pattern of the ultrasonic signal emitted by the pressure sensor 2300 is differently determined according to the fine valleys and ridges which are present in the fingerprint. Assuming a case in which no object contacts a contact surface such as the one surface of the protective layer 500, most of the ultrasonic signal generated from the pressure sensor 2300 due to the difference in media between the contact surface and air cannot pass through the contact surface but is reflected and returned. Conversely, when a specific object including a fingerprint contacts the contact surface, a portion of the ultrasonic signal which is generated from the pressure sensor 2300 directly contacting the ridges of the fingerprint passes through the interface between the contact surface and the fingerprint, and only a portion of the generated ultrasonic signal is reflected and returned. As such, the strength of the reflected and returned ultrasonic signal may be determined according to the acoustic impedance of each material. Consequently, the signal detection unit 6200 measures, from the pressure sensor 2300, the difference in the acoustic impedance generated by the ultrasonic signal at the valleys and ridges of the fingerprint, and may determine whether the corresponding region is the sensor in contact with the ridges of the fingerprint.

The calculation unit 6300 analyzes the signal detected by the signal detection unit 6200 and calculates the fingerprint pattern. The pressure sensor 2300 in which a low-strength reflected signal is generated is the pressure sensor 2300 contacting the ridges of the fingerprint, and the pressure sensor 2300 in which a high-strength signal is generated—ideally, the same strength as the strength of the output ultrasonic signal—is the pressure sensor 2300 corresponding to the valleys of the fingerprint. Accordingly, the fingerprint pattern may be calculated from the difference in the acoustic impedance detected from each region of the pressure sensor 2300.

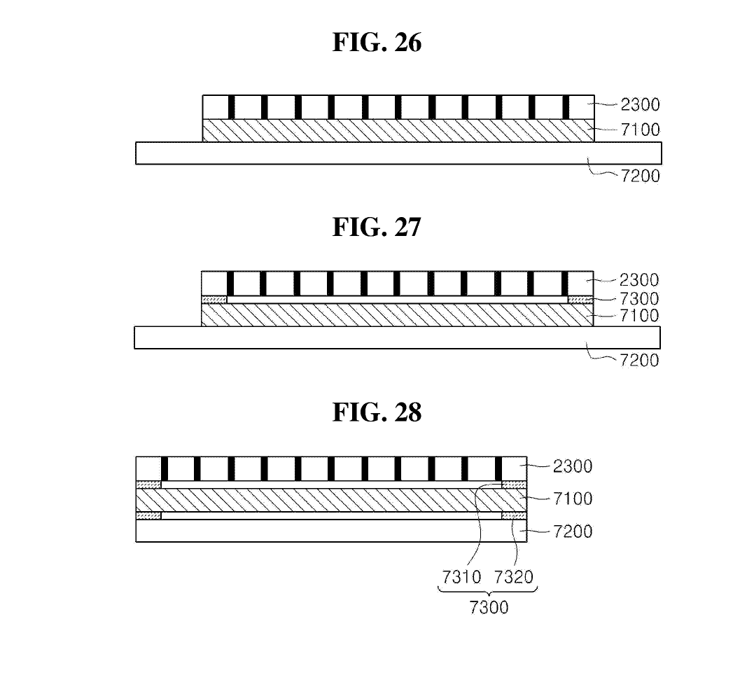

Meanwhile, the pressure sensor in accordance with exemplary embodiments may be provided as a complex device by being combined with a haptic device, a piezoelectric buzzer, a piezoelectric speaker, NFC, WPC, and magnetic secure transmission (MST), or the like. That is, the pressure sensor in accordance with exemplary embodiments may implement a complex device by being coupled with a functioning unit which serves a different function from the pressure sensor. FIGS. 26 to 28 illustrate complex devices provided with a pressure sensor in accordance with an exemplary embodiment. Here, any one structure in various exemplary embodiments described by using FIGS. 1, 11, and 7 may be used for a pressure sensor 2300.

As described in FIG. 26, a piezoelectric device 7100 may be formed on a vibration plate 7200, and the pressure sensor 2300 in accordance with exemplary embodiments may be provided above the piezoelectric device 7100. The piezoelectric device 7100 may be formed in a bimorph type having piezoelectric layers on both surfaces of a substrate, and may also be formed in a unimorph type having a piezoelectric layer on one surface of the substrate. In addition, electrodes may respectively be formed on upper and lower portions of the piezoelectric layer. That is, the piezoelectric device 7100 may be implemented by stacking a plurality of piezoelectric layers and a plurality of electrodes alternately. Here, the piezoelectric body 310 may be formed by using a piezoelectric material based on PZT (Pb, Zr, Ti), NKN (Na, K, Nb), and BNT (Bi, Na, Ti). The vibration plate 7200 may be provided so as to have the same shape as the piezoelectric device 7100 and the pressure sensor 2300, and may be provided larger than the piezoelectric device 7100. The piezoelectric device 7100 may be adhered with an adhesive on the upper surface of the vibration plate 7200. Metal or a polymer- or pulp-based material may be used for such a vibration plate 7200. For example, a resin film may be used for the vibration plate 7200, and a material having the young's modulus of 1 MPa to 10 GPa and a large loss coefficient, such as, an ethylene propylene rubber-based material and a styrene butadiene rubber-based material may be used. Such a vibration plate 7200 amplifies the vibration of the piezoelectric device 7100.

As such, the piezoelectric device 7100 provided between the vibration plate 7200 and the pressure sensor 2300 may be operated as a piezoelectric acoustic device or a piezoelectric vibration device according to a signal applied through an electronic device, that is, an alternating current power source. That is, the piezoelectric device 7100 may be used, according to an applied signal, as an actuator which generates a predetermined vibration, that is, as a haptic device, or may be used as a piezoelectric buzzer or a piezoelectric speaker which generates a predetermined sound.

Meanwhile, the piezoelectric sensor 2300 and the piezoelectric device 7100 may be adhered with an adhesive or the like, and may also be integrally formed. When the pressure sensor 2300 and the piezoelectric device 7100 are integrally manufactured, the pressure sensor 2300 can have the structure described by using FIGS. 7 and 8. That is, the first electrode may be formed on a portion in which a plurality of piezoelectric layers and electrodes are alternately stacked and on an upper portion thereof, and the piezoelectric layer 300 is formed on the second electrode, and the second electrode is formed on the piezoelectric layer. At this point, the first electrode is formed by patterning, the piezoelectric layer 300 may be cut into predetermined cell units by a plurality of cutaway portions, and the second electrode may be formed by patterning on the piezoelectric layer.

In addition, when the piezoelectric device 7100 is used as a piezoelectric buzzer or a piezoelectric speaker, preferably, a predetermined resonance space is provided between the piezoelectric device 7100 and the pressure sensor 2300. That is, as illustrated in FIG. 27, a support 7300 with a predetermined thickness may be provided on an edge between the piezoelectric device 7100 and the pressure sensor 2300. A polymer may be used for the support 7300. According to the height of the support 7300, the size of the resonance space between the piezoelectric device 7100 and the pressure sensor 2300 may be adjusted. Meanwhile, the support 7300 may also be implemented such that an adhesive tape or the like is provided along the periphery of the piezoelectric device 7100 and the pressure sensor 2300. In addition, as illustrated in FIG. 28, not only a first support 7310 may be formed on an edge between the piezoelectric device 7100 and the pressure sensor 2300, but also a second support 7320 may also be provided between piezoelectric device 7100 and the vibration plate 7200, whereby a predetermined resonance space may be provided.

In addition, the pressure sensor may be coupled to NFC, WPC, and MST, and may also implement a complex device by being coupled to each of NFC, WPC, and MST or coupled to at least two or more thereof. The NFC, WPC, and MST may be formed in antenna patterns with predetermined shapes on a predetermined sheet. Of course, the complex device may also be manufactured such that a pressure sensor and at least one among a piezoelectric speaker, a piezoelectric actuator, a WPC antenna, an NFC antenna and an MST antenna are integrated. In addition, multiple functions are achieved with one module, and thus, compared to the case in which each of the functions is individually provided, the area of the region occupied in the case may be reduced.

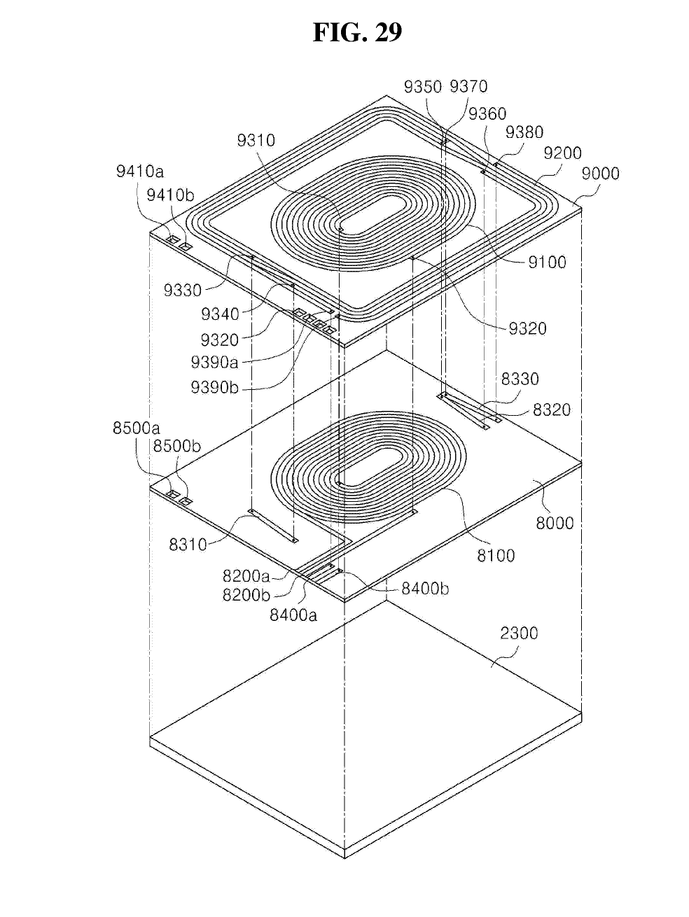

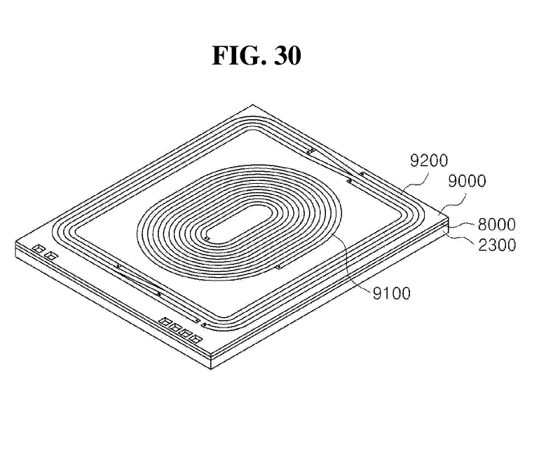

FIGS. 29 and 30 are an exploded perspective view and an assembled perspective view of a complex device including an NFC and a WPC as an example of a complex device including a pressure sensor in accordance with an exemplary embodiment. Of course, the pressure sensor may be coupled to each of an NFC, a WPC, and an MFC, and these NFC, WPC, and MST may be configured from predetermined antenna patterns.

Referring to FIGS. 29 and 30, a complex device may include: a first sheet 8000 which is provided on one surface of the pressure sensor 2300 and has an antenna pattern 8100 formed thereon; and a second sheet which is provided on or under the first sheet 8000 or on the same surface as the first sheet and has a second antenna pattern 9100 and a third antenna pattern 9200 which are formed thereon. Here, the first antenna pattern 8100 of the first sheet 8000 and the second antenna pattern 9100 of the second sheet 9000 are connected to each other and thereby form a wireless power charge (WPC) antenna, and the third antenna pattern 9200 of the second sheet 9000 is formed outside the second antenna pattern 9100 and thereby forms a near field communication (NFC) antenna. That is, the complex device module in accordance with an exemplary embodiment may be provided such that a pressure sensor, a WPC antenna, an NFC antenna are integrated.

The first sheet 8000 is provided on one surface of the pressure sensor 2300 and has the first antenna pattern 8100 formed thereon. In addition, the first sheet 8000 is provide with: first and second extracting patterns 8200a and 8200b which are connected to the first antenna pattern 8100 and extracted to the outside; a plurality of connection patterns 8310, 8320 and 8330 which connect the third antenna pattern 9200 formed on the second sheet 9000; and third and fourth extracting patterns 8400a and 8400b which are connected to the third antenna pattern 9200 and extracted to the outside. Such a first sheet 8000 may be provided in the same shape as the pressure sensor 2300. That is, the first sheet 8000 may be provided in an approximately rectangular plate-shape. At this point, the thickness of the first sheet 8000 may be equal to or different from that of the pressure sensor 2300. The first antenna pattern 8100 may be formed in a predetermined number of turns, for example, by rotating in one direction from a central part of the first sheet 8000. For example, the first antenna pattern 8100 may be formed in a spiral shape which has a predetermined width and intervals and outwardly rotates counterclockwise. At this point, the wire widths and intervals of the first antenna pattern 8100 may be the same or different. That is, the first antenna pattern 8100 may have the wire width greater than interval. Also, the end of the first antenna pattern 8100 is connected to the first extracting pattern 8200a. The first extracting pattern 8200a is formed in a predetermined width and formed to be exposed toward one side of the first sheet 8000. For example, the first extracting pattern 8200a is formed to extend in the direction of the long-side of the first sheet 8000 and be exposed toward one short side of the first sheet 8000. In addition, the second extracting pattern 8200b is spaced apart from the first extracting pattern 8200a and is formed in the same direction as the first extracting pattern 8200a. Such a second extracting pattern 8200b is connected to the second antenna pattern 9100 formed on the second sheet 9000. Here, the second extracting pattern 8200b may be formed longer than the first extracting pattern 8200a. In addition, a plurality of connection patterns 8310, 8320 and 8330 are provided to connect the third antenna pattern 9200 formed on the second sheet 9000. That is, the third antenna pattern 9200 is formed in, for example, a semi-circular shape in which at least two regions are disconnected, and a plurality of connection patterns 8210, 8220, and 8230 are formed on the first sheet 8000 to connect the two regions to each other. The connection pattern 8210 is formed in a predetermined width and a predetermined length in the direction of one short side in a region between the first extracting patterns 8200a. The connection patterns 8220 and 8230 are formed on the position facing the connection pattern 8210 in the long-side direction, that is, on the other short side on which the first and second extraction patterns 8200a and 8200b are not formed, and are formed in predetermined widths and lengths on the other short side in the direction of the other short side without being exposed to the other short side. In addition, the connection patterns 8220 and 8230 are formed to be spaced apart from each other. In addition, the third and fourth extracting patterns 8400a and 8400b are formed to be spaced apart from the second extracting pattern 8200b, and formed to be exposed to the one short side. Meanwhile, through holes 8500a and 8500b are formed to be individually separated in the region in which the extracting patterns 8200 and 8400 of the one side on which the extracting patterns 8200 and 8400 are formed are not formed. In addition, the extracting patterns 8200 and 8400 are connected to the connection terminal (not shown) and connected to an electronic device through the terminal. Meanwhile, the first sheet 8000 may be manufactured by using magnetic ceramic. For example, the first sheet 8000 may be formed by using NiZnCu- or NiZn-based magnetic body. Specifically, in the NiZnCu-based magnetic sheet, Fe₂O₃, ZnO, NiO, CuO may be added as a magnetic body, and Fe₂O₃, ZnO, NiO, and CuO may be added in a ratio of 5:2:2:1. As such, the first sheet 8000 is manufactured by using magnetic ceramic, and thus, electromagnetic waves generated from the WPC antenna and the NFC antenna may be shielded or absorbed. Thus, the interference of the electromagnetic waves may be suppressed.

The second sheet 9000 is provided on the first sheet 8000, and the second antenna pattern 9100 and the third antenna pattern 9200 are formed to be spaced apart from each other. In addition, a plurality of holes 9310, 9320, 9330, 9340, 9350, 9360, 9370, and 9380 are formed in the second sheet 9000. Such a second sheet 9000 may be provided in the same shape as the pressure sensor 2300 and the first sheet 8000. That is, the second sheet 9000 may be provided in an approximately rectangular plate-shape. At this point, the thickness of the second sheet 9000 may be equal to or different from that of the pressure sensor 2300 and the first sheet 8000. That is, the second sheet 9000 may be provided in a smaller thickness than the pressure sensor 2300 and the same thickness as the first sheet 8000. The second antenna pattern 9100 may be formed in a predetermined number of turns, for example, by rotating in one direction from a central part of the second sheet 9000. For example, the second antenna pattern 9100 may be formed in a spiral shape which has a predetermined width and interval and outwardly rotates clockwise. That is, the second antenna pattern 9100 may be formed in a spiral shape rotating clockwise from the same region as the first antenna pattern 8100 formed on the first sheet 8000, and formed up to the region overlapping the second extraction pattern 8200b formed on the first sheet 8000. At this point, the wire width and the interval of the second antenna pattern 9100 may be the same as the wire width and the interval of the first antenna pattern 8100, and the second antenna pattern 9100 and the first antenna pattern 8100 may overlap. In the starting position and the end position of the second antenna pattern 9100, holes 9310 and 9320 are respectively formed, and the holes 9310 and 9320 are filled with a conductive material. Accordingly, the starting position of the second antenna pattern 9100 is connected to the starting position of the first antenna pattern 8100 through the hole 9310, and the end position of the second antenna pattern 9100 is connected to a predetermined region of the second extracting pattern 8200b through the hole 9320. The third antenna pattern 9200 is formed to be spaced apart from the second antenna pattern 9100 and is formed in a plurality of numbers of turns along the periphery of the second sheet 9000. That is, the third antenna pattern 9200 is provided to surround the second antenna pattern 9100 from the outside. At this point, the third antenna pattern 9200 is formed in a shape disconnected in a predetermined region on the second sheet 9000. That is, the third antenna pattern 9200 is not formed in a plurality of numbers of turns connected to each other, but may be formed in a shape disconnected in at least two regions and electrically disconnected from each other on the second sheet 9000. As such a plurality of holes 9330, 9340, 9350, 9360, 9370 and 9380 are formed between the third antenna patterns 9200 disconnected from each other. Also, the plurality of holes 9330, 9340, 9350, 9360, 9370 and 9380 are filled with a conductive material and respectively connected to the connection patterns 8310, 8320 and 8330 of the first sheet 8000. Accordingly, the third antenna pattern 9200 is formed in a form which is disconnected in at least two regions, but may be electrically connected to each other through the plurality of holes 9330, 9340, 9350, 9360, 9370 and 9380 and the connection patterns 8310, 8320 and 8330 of the first sheet 8000. In addition, in the second sheet 9000, a plurality of through holes 9410 and 9420, which respectively expose the through holes 8500a and 8500b of the first sheet 8000 and the plurality of extracting patterns 8200 and 8400, are formed. In addition, the four through holes 9420 are formed so as to expose the plurality of, that is, four extracting patterns 8200 and 8400 of the first sheet 8000. Meanwhile, the second sheet 9000 may be manufactured by using a material different from that of the first sheet 8000. For example, the second sheet 9000 may be manufactured by using nonmagnetic ceramic, that is, manufactured by using low temperature co-fired ceramic (LTCC).

Meanwhile, the antenna patterns 8100, 9100 and 9200, extracting patterns 8200 and 8400, connection patterns 8310, 8320 and 8330, and the like are formed by using copper foils or a conductive paste, and when formed by using the conductive paste, the conductive paste may be printed on the sheet through various printing methods. As conductive particles of the conductive paste, metal particles of gold (Au), silver (Ag), nickel (Ni), copper (Cu), palladium (Pd), silver-coated copper (Ag coated Cu), silver-coated nickel (Ag coated Ni), nickel-coated copper (Ni coated Cu), and nickel-coated graphite (Ni coated graphite), carbon nanotubes, carbon black, graphite, silver-coated graphite (Ag coated graphite), or the like may be used. The conductive paste is a material, in which conductive particles are uniformly dispersed in a fluidic organic binder, is applied on a sheet through a method such as printing, and thereby exhibits electrical conductivity by heat treatment, such as, drying, cure, and baking. In addition, as a printing method, planography such as screen printing, roll-to-roll printing such as gravure printing, inkjet printing, or the like may be used.

The present invention may, however, be embodied in different forms and should not be construed as limited to the embodiments set forth herein. That is, the above embodiments are provided so that this invention will be thorough and complete, and will fully convey the scope of the present invention to those skilled in the art, and the scope of the present invention should be understood by the scopes of claims of the present application.

1. A pressure sensor comprising:
first and second electrode layers spaced apart from each other; and
a dielectric layer provided between the first and second electrode layers, wherein
the dielectric layer is compressible and restorable, and comprises at least one among a material with a hardness of 10 or less, a plurality of dielectric bodies with a dielectric constant of 4 or less, and a plurality of pores.

2. The pressure sensor of claim 1 further comprising a plurality of holes formed in at least any one of the first and second electrode layers.

3. The pressure sensor of claim 1, wherein the dielectric layer further comprises a material for shielding and absorbing electromagnetic waves.

4. The pressure sensor of claim 1, wherein the dielectric layer comprises the dielectric bodies which are formed in a content of 0.01% to 95% based on 100% of the dielectric layer.

5. The pressure sensor of claim 1, wherein the dielectric layer has a porosity of 1% to 95%.

6. The pressure sensor of claim 5, wherein the pores are formed in two or more sizes and at least one or more shapes.

7. The pressure sensor of claim 5, wherein the dielectric layer has at least one region having a porosity or a pore size different from other regions.

8. The pressure sensor of claim 5, wherein the dielectric layer has a smaller pore cross-sectional area ratio in a vertical cross-section thereof than in the horizontal cross-section thereof.

9. The pressure sensor of claim 1, wherein the dielectric layer has a dielectric constant of 2 to 20.

10. The pressure sensor of claim 1, wherein the dielectric layer is formed in a thickness of 500 μm or less.

11. The pressure sensor of claim 1, further comprising an insulating layer provided on at least one among places on the first electrode layer, between the first and second electrode layers, and under the second electrode layer.

12. The pressure sensor of claim 1, further comprising first and second connection patterns respectively provided on the first and second electrode layers and connected to each other.

13. A complex device comprising:
a pressure sensor set forth in claim 1; and
at least one functional part having a function different from that of the pressure sensor.

14. The complex device of claim 13, wherein the pressure sensor enables the functional part.

15. The complex device of claim 13, wherein the functional part comprises:
a piezoelectric device provided on one side of the pressure sensor; and
a vibration plate provided on one side of the piezoelectric device.

16. The complex device of claim 15, wherein the piezoelectric device is used as a piezoelectric vibration apparatus or a piezoelectric acoustic apparatus according to an applied signal.

17. The complex device of claim 13, wherein the functional part is provided on one side of the pressure sensor and comprises at least one among an NFC, a WPC, and an MST each of which comprises at least one antenna pattern.

18. The complex device of claim 13, wherein the functional part comprises:
a piezoelectric device provided on one surface of the pressure sensor;
a vibration plate provided on one surface of the piezoelectric device; and
at least one among an NFC, a WPC, and an MST which are provided on the other surface of the pressure sensor or on one surface of the vibration plate.

19. The complex device of claim 13 comprising a fingerprint detection unit electrically connected to the pressure sensor and configured to measure, from the pressure sensor, a difference in acoustic impedance generated by an ultrasonic signal at valleys and ridges of the fingerprint and thereby detects a fingerprint.

20. (canceled)

21. (canceled)

22. (canceled)

23. (canceled)

24. (canceled)
